(19) United States
(12) Patent Application Publication
(10) Pub. No.: US 2026/0016801 A1
(43) Pub. Date: Jan. 15, 2026

(54) BUILDING SYSTEM WITH WORKFLOW INTEGRATION

(71) Applicant: Tyco Fire & Security GmbH, Neuhausen am Rheinfall (CH)

(72) Inventors: Tushar Kshirsagar, Allentown, PA (US); Kerry M. Caravello, Mukwonago, WI (US); Sourabh Taranath Joshi, Thane Mumbai (IN); Koel Biswas, Dumdum (IN)

(21) Appl. No.: 19/266,434

(22) Filed: Jul. 11, 2025

(30) Foreign Application Priority Data
Jul. 12, 2024 (IN) 202441053432

(51) Int. Cl. G05B 19/042

(52) U.S. Cl. CPC G05B 19/042; G05B 2219/25011

(57) ABSTRACT

A building system can include one or more memory devices. The one or more memory devices can store instructions thereon that, when executed by one or more processors, cause the one or more processors to evaluate incoming building data generated by building equipment of a building relative to a condition defined by a stored workflow, detect an event in response to at least a portion of the incoming building data satisfying the condition of the stored workflow, and execute a set of actions defined by the stored workflow.

### CROSS-REFERENCE TO RELATED PATENT APPLICATIONS

This application claims the benefit of and priority to Indian Provisional Patent Application No. 202441053432, filed Jul. 12, 2024, the entirety of which is incorporated by reference herein.

### BACKGROUND

The present disclosure relates generally to systems and methods for building control. The present disclosure relates more particularly to implementation of standard operating procedures (SOPs) or workflows with regard to building maintenance, monitoring of facilities, and security.

### SUMMARY

At least one embodiment relates to a building system. The building system can monitor and control a building. The building system can include one or more memory devices. The one or more memory devices can store instructions. The instructions can, when executed by one or more processors, cause the one or more processors to evaluate incoming building data generated by building equipment of the building relative to a condition defined by a stored workflow. The incoming building data can include camera data generated by a camera of the building. The instructions can cause the one or more processors to detect an event in response to the camera data satisfying the condition of the stored workflow. The instructions can cause the one or more processors to execute, responsive to detection of the event, a set of actions defined by the stored workflow. The set of actions can include identifying a building space observed by the camera based on the camera data, querying a digital representation of the building to identify lighting equipment operable to illuminate the building space observed by the camera, and operating the lighting equipment to illuminate the building space observed by the camera.

In some embodiments, the digital representation can be a digital twin including a plurality of points having one or more connections to indicate relationships between respective points of the plurality of points. The camera can be represented within the digital twin as a first point of the plurality of points. The lighting equipment can be represented within the digital twin as a second point of the plurality of points. The first point can be connected to the second point via a first connection of the one or more connections. The instructions can cause the one or more processors to detect, responsive to querying the digital twin, the first connection between the first point and the second point. The instructions can cause the one or more processors to determine, based on one or more relationships indicated by the first connection, that the second point pertains to the lighting equipment. The instructions can cause the one or more processors to identify the lighting equipment based at least on the second point pertaining to the lighting equipment.

In some embodiments, the event can be an intrusion event. The instructions can cause the one or more processors to monitor the camera data for one or more criteria that define the intrusion event. The instructions can cause the one or more processors to detect the intrusion event in response to the one or more criteria being satisfied.

In some embodiments, the digital representation can be a digital twin. The instructions can cause the one or more processors to identify the building space observed by the camera using a stored relationship of the digital twin that is between the camera and a location of the camera.

In some embodiments, identifying the building space observed by the camera can include determining a location of the camera and an orientation of the camera, wherein the location of the camera is within the building space observed by the camera or a second building space proximate to the building space observed by the camera.

In some embodiments, querying the digital representation can include identifying a stored relationship in the digital representation between the building space observed by the camera and the lighting equipment.

In some embodiments, the instructions can cause the one or more processors to create the stored workflow. Creation of the stored workflow can include the one or more processors to replace, responsive to receipt of a first indication, at least one portion of a user interface with an area configured to receive interactions to create the stored workflow. Creation of the stored workflow can include the one or more processors to detect one or more interactions with the area, the one or more interactions including a second indication of the set of actions for inclusion in the stored workflow. Creation of the stored workflow can include the one or more processors to store one or more sets of information associated with the one or more interactions to create the stored workflow having the set of actions.

In some embodiments, the stored workflow can be associated with a stored standard operating procedure. The instructions can cause the one or more processors to determine to initiate an instance of the stored standard operating procedure using data obtained from one or more functions of a plurality of different functions of a building management platform. The instructions can cause the one or more processors to execute, responsive to initiation of the instance of the stored standard operating procedure, at least one action associated with the stored standard operating procedure to retrieve one or more sets of information from one or more platforms of a building management system and transmit one or more signals to cause the one or more platforms to control one or more aspects of the building based on the one or more sets of information.

In some embodiments, the building can include one or more aspects that pertain to at least one of energy consumption of the building, statuses of the building equipment of the building, previously detected faults for the building equipment, or maintenance records for the building equipment.

In some embodiments, the instructions can cause the one or more processors to transmit one or more Application Programming Interface (API) calls to retrieve one or more sets of information that indicate one or more aspects of the building. The instructions can cause the one or more processors to ingest, responsive to retrieval of the one or more sets of information, at least a portion of the one or more sets of information into a building management platform to provide a context of the building.

In some embodiments, the instructions can cause the one or more processors to detect, via one or more interactions with a user interface, a selection of at least one second stored workflow awaiting acceptance prior to integration with one or more building systems of the building. The instructions can cause the one or more processors to update, responsive to detection of the selection of the at least one second stored workflow, the user interface to display one or more actions to perform the at least one second stored workflow. The instructions can cause the one or more processors to integrate, responsive to acceptance of the at least one second stored workflow via the user interface, the at least one second stored workflow with the one or more building systems.

In some embodiments, the set of actions can include causing, responsive to detection of the event, the camera to generate a recording of the building space observed by the camera. The set of actions can include storing, responsive to generation of the recording, the recording in the digital representation of the building. The set of actions can include transmitting one or more signals to a display device to cause the display device to present the recording.

At least one embodiment relates to a method. The method can include evaluating, by one or more processing circuits, incoming building data generated by building equipment of a building relative to a condition defined by a stored workflow. The incoming building data can include camera data generated by a camera of the building. The method can include detecting, by the one or more processing circuits, an event in response to the camera data satisfying the condition of the stored workflow. The method can include executing, by the one or more processing circuits, responsive to detecting the event, a set of actions defined by the stored workflow. The set of actions can include identifying a building space observed by the camera based on the camera data, querying a digital representation of the building to identify lighting equipment operable to illuminate the building space observed by the camera, and operating the lighting equipment to illuminate the building space observed by the camera.

In some embodiments, the digital representation can be a digital twin including a plurality of points having one or more connections to indicate relationships between respective points of the plurality of points. The camera can be represented within the digital twin as a first point of the plurality of points. The lighting equipment can be represented within the digital twin as a second point of the plurality of points. The first point can be connected to the second point via a first connection of the one or more connections. The method can include detecting, by the one or more processing circuits, responsive to querying the digital twin, the first connection between the first point and the second point. The method can include determining, by the one or more processing circuits, based on one or more relationships indicated by the first connection, that the second point pertains to the lighting equipment. The method can include identifying, by the one or more processing circuits, the lighting equipment based at least on the second point pertaining to the lighting equipment.

In some embodiments, the event can be an intrusion event. The method can include monitoring, by the one or more processing circuits, the camera data for one or more criteria that define the intrusion event. The method can include detecting, by the one or more processing circuits, the intrusion event in response to the one or more criteria being satisfied.

In some embodiments, the digital representation can be a digital twin. The method can include identifying, by the one or more processing circuits, the building space observed by the camera using a stored relationship of the digital twin that is between the camera and a location of the camera.

In some embodiments, identifying the building space observed by the camera can include determining, by the one or more processing circuits, a location of the camera and an orientation of the camera, wherein the location of the camera is within the building space observed by the camera or a second building space proximate to the building space observed by the camera.

At least one embodiment relates to a building system. The building system can monitor and control a building. The building system can include one or more memory devices. The one or more memory devices can store instructions. The instructions can, when executed by one or more processors, cause the one or more processors to evaluate incoming building data associated with building equipment of the building relative to a condition defined by a stored workflow. The incoming building data can include data associated with lighting equipment of the building. The instructions can cause the one or more processors to detect an instance of an event based on the data associated with the lighting equipment satisfying the condition of the stored workflow. The instructions can cause the one or more processors to execute, responsive to detection of the instance of the event, a set of actions defined by the stored workflow. The set of actions can include retrieving one or more sets of data associated the event, identifying one or more devices, and transmitting, to the one or more devices, one or more signals to cause the one or more devices to display an alert and the one or more sets of data.

In some embodiments, the instructions can cause the one or more processors to monitor the data associated with the lighting equipment for one or more criteria that define the condition. The instructions can cause the one or more processors to detect the instance of the event in response to the one or more criteria being satisfied.

In some embodiments, the instructions can cause the one or more processors to identify the data associated with the lighting equipment using a stored relationship of a digital twin that is between the lighting equipment and the data associated with the lighting equipment.

### BRIEF DESCRIPTION OF THE DRAWINGS

FIG. 1 is a drawing of a building equipped with a HVAC system, according to some embodiments.

FIG. 2 is a schematic diagram of a waterside system which can be used in conjunction with the building of FIG. 1, according to some embodiments.

FIG. 3 is a schematic diagram of an airside system which can be used in conjunction with the building of FIG. 1, according to some embodiments.

FIG. 4 is a block diagram of a building management system (BMS) which can be used to monitor and control the building of FIG. 1, according to some embodiments.

FIG. 5 is a block diagram of another BMS which can be used to monitor and control the building of FIG. 1, according to some embodiments.

FIG. 6 is a block diagram of a system to integrate standard operating procedures (SOPs) into a building management system, according to some embodiments.

FIG. 7 is an example user interface to display information associated with SOPs for a building, according to some embodiments.

FIG. 8 is an example user interface to display information associated with SOPs for a building, according to some embodiments.

FIG. 9 is an example user interface to display information associated with SOPs for a building, according to some embodiments.

FIG. 10 is an example user interface to display information associated with SOPs for a building, according to some embodiments.

FIG. 11 is an example user interface to display information associated with SOPs for a building, according to some embodiments.

FIG. 12 is an example user interface to display information associated with SOPs for a building, according to some embodiments.

FIG. 13 is an example user interface to display information associated with SOPs for a building, according to some embodiments.

FIG. 14 is an example user interface to display information associated with SOPs for a building, according to some embodiments.

FIG. 15 is an example user interface to display information associated with SOPs for a building, according to some embodiments.

FIG. 16 is an example user interface to display information associated with SOPs for a building, according to some embodiments.

FIG. 17 is an example user interface to display information associated with SOPs for a building, according to some embodiments.

FIG. 18 is an example user interface to display information associated with one or more platforms of a Building Management System, according to some embodiments.

FIG. 19 is a flow diagram of a method to integrate SOPs with a building management system, according to some embodiments.

FIG. 20 is a flow diagram of a method to create one or more SOPs, according to some embodiments.

FIG. 21 is a flow diagram of a method to implement a workflow, according to some embodiments.

FIG. 22 is a flow diagram of a method to implement a workflow, according to some embodiments.

### DETAILED DESCRIPTION

The present disclosure describes system and methods to integrate standard operating procedures (SOPs) into a Building Management System (BMS). For example, SOPs to maintain and/or operate a building may be integrated into the BMS. As another example, SOPs to generate alerts or updates may be integrated into the BMS. Integration of SOPs into a BMS may provide consistency or reliability with respect to responses within a building. For example, integration of a given SOP within a BMS may ensure that a given response or action is implemented based on a trigger of the given SOP. As another example, integration of SOPs may assist with maintenance or fault detection with respect to various systems and/or equipment within a building.

Some technical solutions described herein include presenting information via a user interface such that information corresponding to various SOPs of a building may be presented and/or modified based on various interactions with the user interface. For example, a user interface may be generated to present information corresponding to currently active SOPs withing a BMS. As another example, a user interface may be generated to present tools or other possible elements to create SOPs for a building. Additionally, the user interface may be updated and/or modified based on changes to statuses of a building. For example, the user interface may include a running toll of currently active SOPs and the user interface may be updated responsive to triggering of an additional SOP and/or responsive to completion of an additional SOP. The dynamic properties of the user interface may provide the user interface to include an overall view of SOPs with respect to a building and/or BMS while also allowing for a user to drill down information specific to a given SOP.

### Building and HVAC System

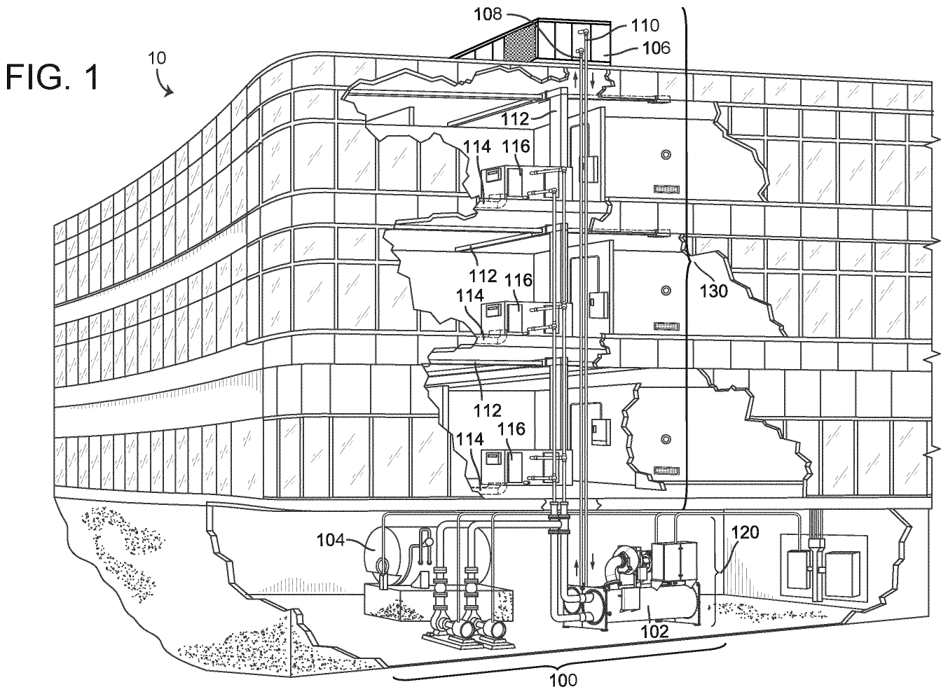

Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

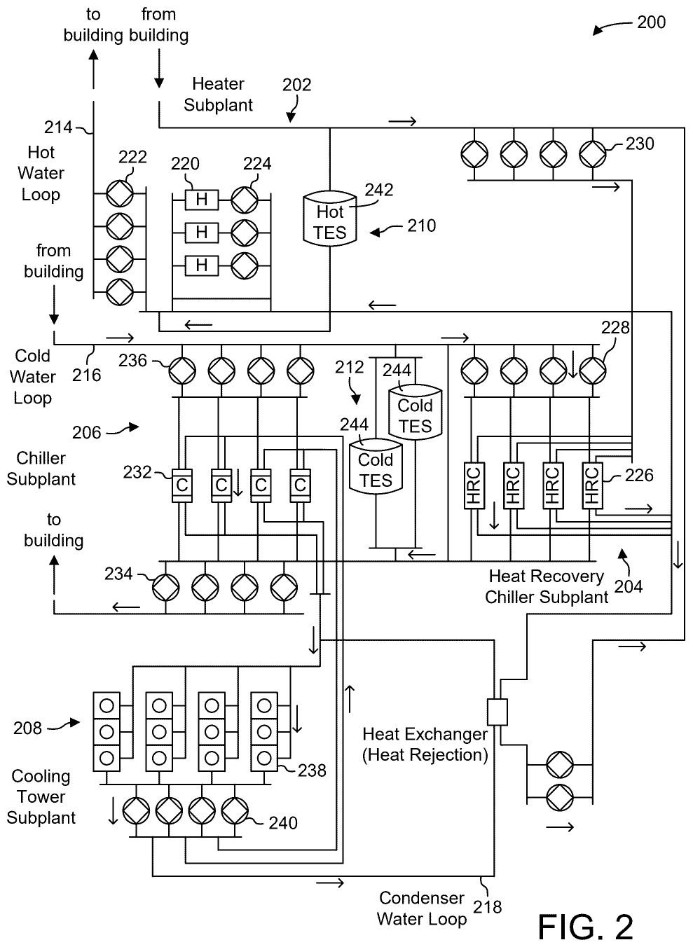

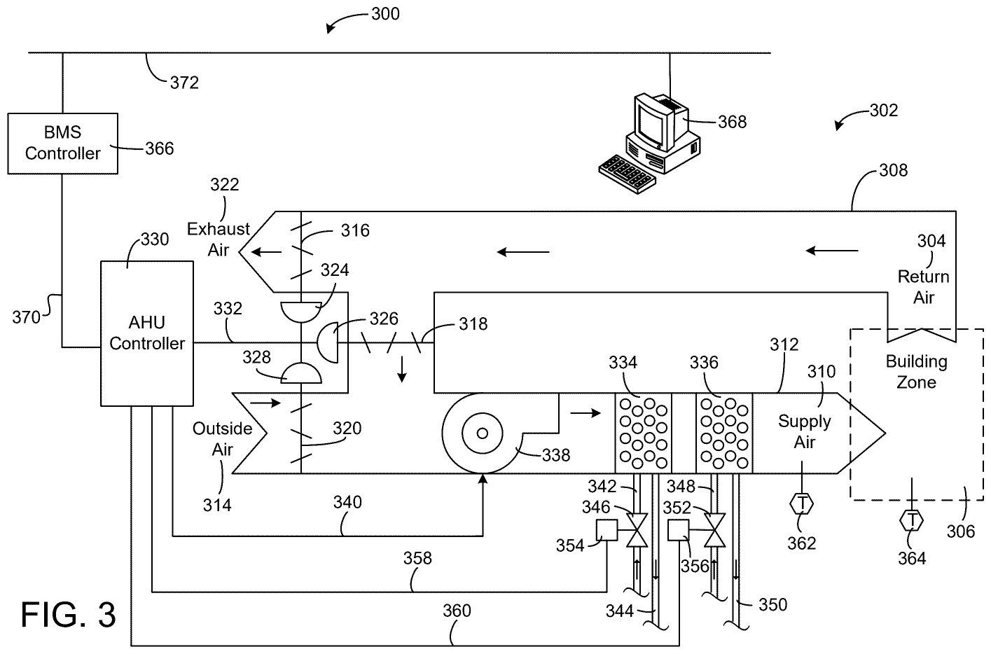

The BMS that serves building 10 includes a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present disclosure.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES 242 configured to store the hot water for later use. Hot TES subplant 210 may also include one or more pumps or valves configured to control the flow rate of the hot water into or out of hot TES 242. Cold TES subplant 212 is shown to include cold TES 244 configured to store the cold water for later use. Cold TES subplant 212 may also include one or more pumps or valves configured to control the flow rate of the cold water into or out of cold TES 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to the AHU controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management Systems

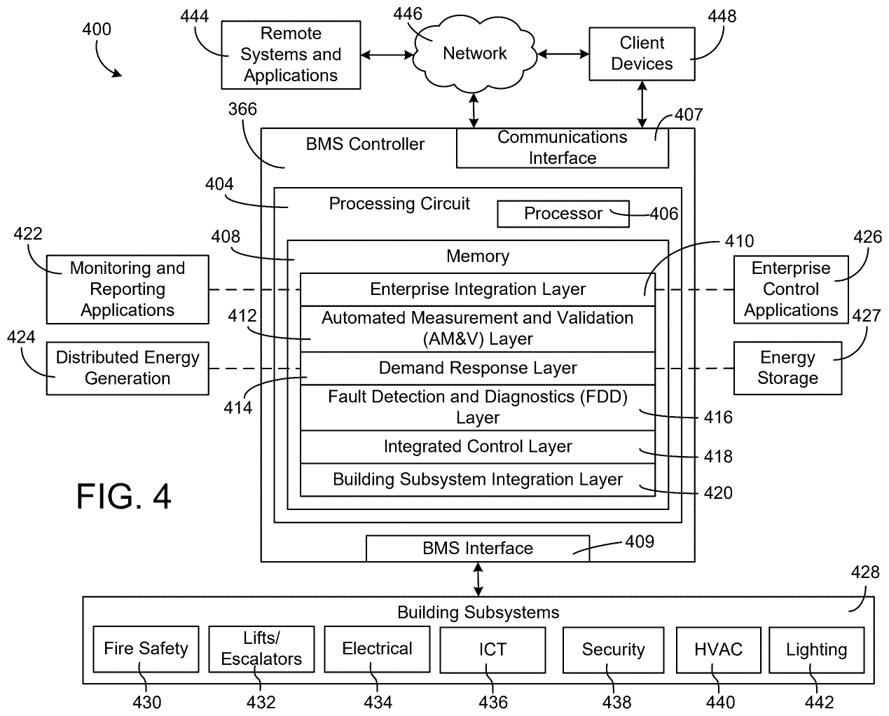

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can refer to or include non-transitory storage media or non-transitory storage medium. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

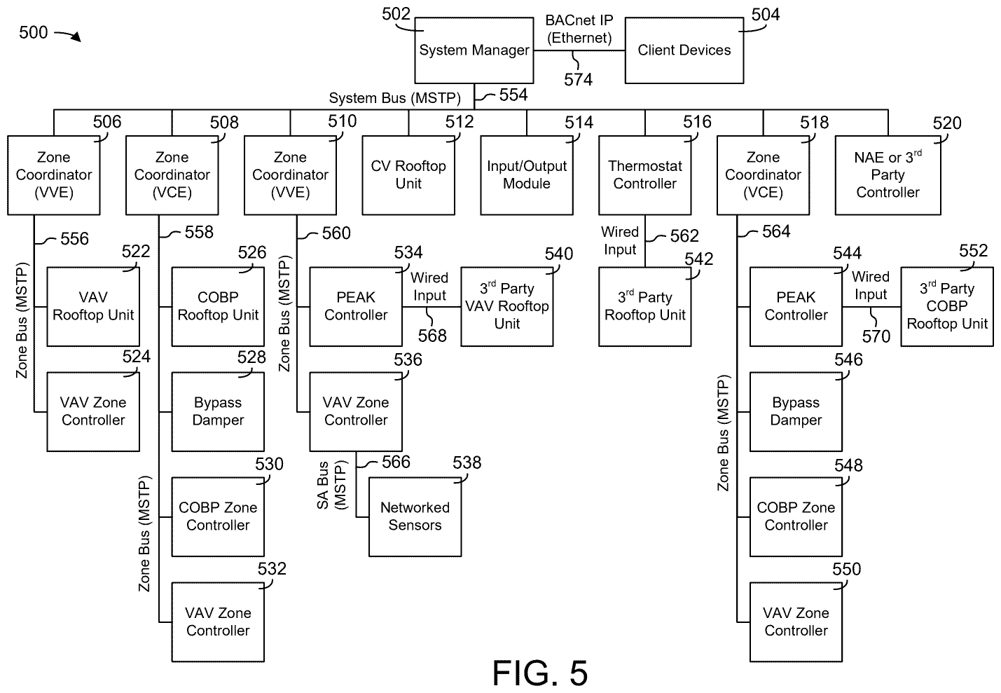

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a system manager 502; several zone coordinators 506, 508, 510 and 518; and several zone controllers 524, 530, 532, 536, 548, and 550. System manager 502 can monitor data points in BMS 500 and report monitored variables to various monitoring and/or control applications. System manager 502 can communicate with client devices 504 (e.g., user devices, desktop computers, laptop computers, mobile devices, etc.) via a data communications link 574 (e.g., BACnet IP, Ethernet, wired or wireless communications, etc.). System manager 502 can provide a user interface to client devices 504 via data communications link 574. The user interface may allow users to monitor and/or control BMS 500 via client devices 504.

In some embodiments, system manager 502 is connected with zone coordinators 506-510 and 518 via a system bus 554. System manager 502 can be configured to communicate with zone coordinators 506-510 and 518 via system bus 554 using a master-slave token passing (MSTP) protocol or any other communications protocol. System bus 554 can also connect system manager 502 with other devices such as a constant volume (CV) rooftop unit (RTU) 512, an input/output module (IOM) 514, a thermostat controller 516 (e.g., a TEC5000 series thermostat controller), and a network automation engine (NAE) or third-party controller 520. RTU 512 can be configured to communicate directly with system manager 502 and can be connected directly to system bus 554. Other RTUs can communicate with system manager 502 via an intermediate device. For example, a wired input 562 can connect a third-party RTU 542 to thermostat controller 516, which connects to system bus 554.

System manager 502 can provide a user interface for any device containing an equipment model. Devices such as zone coordinators 506-510 and 518 and thermostat controller 516 can provide their equipment models to system manager 502 via system bus 554. In some embodiments, system manager 502 automatically creates equipment models for connected devices that do not contain an equipment model (e.g., IOM 514, third party controller 520, etc.). For example, system manager 502 can create an equipment model for any device that responds to a device tree request. The equipment models created by system manager 502 can be stored within system manager 502. System manager 502 can then provide a user interface for devices that do not contain their own equipment models using the equipment models created by system manager 502. In some embodiments, system manager 502 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

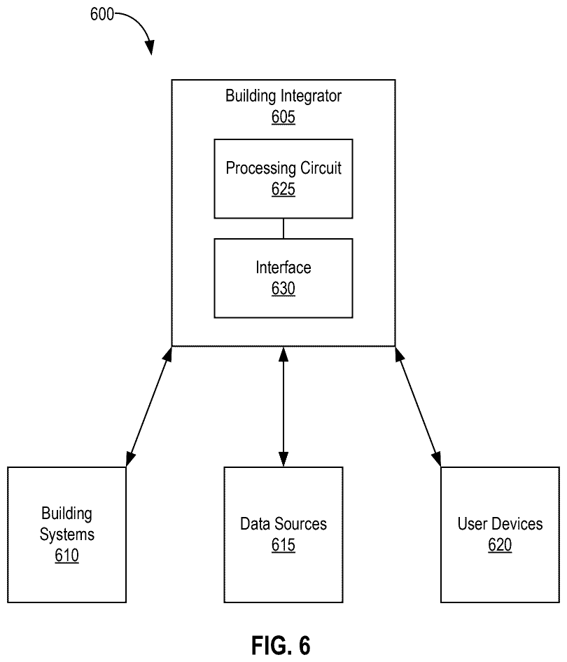

FIG. 6 depicts a system 600 to integrate SOPs with a BMS, according to some embodiments. For example, the system 600 may integrated SOPs with the BMS 500. In some embodiments, the system 600 and/or one or more systems, devices, and/or components thereof may be integrated with and/or implemented by at least one of the various systems, devices, and/or components described herein. For example, the BMS controller 366 may implement the system 600. As another example, the system 600 may be integrated with the BMS 400. In some embodiments, the system 600 may be modified, adjusted, and/or otherwise changed such that one or more systems, devices, and/or components thereof may be added, removed, relocated, supplemented, substituted, and/or otherwise replaced.

In some embodiments, the various systems, devices, and/or components of the system 600 may include at least one of processing circuits, processors, memory devices, hardware, software, firmware, and/or computer code to perform the various processes described herein. The various systems, devices, and/or components of the system 600 may be communicably coupled with one another such that one or more signals may be exchanged. For example, a first device and a second device of the system 600 may include network interfaces to exchange information between one another.

In some embodiments, the system 600 may include at least one building integrator 605, at least one building system 610, at least one data source 615, and at least one user device 620. In some embodiments, the building 10 may include the system 600 and/or one or more systems, devices, and/or components thereof. For example, the building 10 may include the building integrator 605. In some embodiments, the building systems 610 may include the various building systems, building subsystems, and/or pieces of equipment described herein. For example, the building systems 610 may include the building subsystems 428. As another example, the building systems 610 may include the AHUs 106.

In some embodiments, the data sources 615 may refer to and/or include at least one of remote databases, servers, server banks, publicly accessible data sources (e.g., websites, social media, data stores, etc.), cloud-computing systems, and/or open data models. For example, the data sources 615 may include a manufacturers website for which information may be retrieved by one or more Application Programming Interface (API) calls. In some embodiments, the data sources 615 may store and/or otherwise maintain at least one of the various SOPs described herein. For example, the data sources 615 may store one or more data structures that represent SOPs for the building 10.

In some embodiments, the user devices 620 may include at least one of the various devices described herein. For example, the user devices 620 may include the client devices 504. As another example, the user devices 620 may include the client devices 368. In some embodiments, the user devices 620 may include at least one of smart phones, mobile devices, tablets, displays, screens, monitors, kiosks, dashboard, televisions, computers, and/or various input and/or output devices.

In some embodiments, the building integrator 605 may include at least one processing circuit 625 and at least one interface 630. The processing circuit 625 and the interface 630 may be communicably coupled with one another such that the processing circuit 625 and the interface 630 may exchange signals and/or information with one another. In some embodiments, the processing circuit 625 may be communicably coupled, via the interface 630, with at least one of the various systems, devices, and/or components described herein. For example, the processing circuit 625 may be communicably coupled with the building systems 610 via the interface 630. In some embodiments, the processing circuit 625 may include at least one of the various hardware, software, firmware, and/or computer code described herein. For example, the processing circuit 625 may include the processor 406. As another example, the processing circuit 625 may include memory 408. In some embodiments, the processing circuit 625 may include one or more memory devices storing instructions (e.g., firmware, software, computer code, executable code, etc.) that causes one or more processors of the processing circuit 625 to perform at least one of the various processes described herein. In some embodiments, the interface 630 may include at least one of the various network devices described herein. For example, the interface 630 may include the BMS interface 409. As another example, the interface 630 may include the interface 407.

In some embodiments, the processing circuit 625 may retrieve one or more data structures. For example, the processing circuit 625 may transmit one or more API calls to the data sources 615. The processing circuit 625 may retrieve one or more data structures, from the data sources 615, responsive to transmission of the API calls. In some embodiments, the processing circuit 625 may retrieve data structures that represent one or more standard operating procedures (SOPs). For example, the data sources 615 may store SOPs (e.g., stored standard operating procedures) as one or more text strings or vectors. To continue this example, the processing circuit 625 may retrieve the vectors (e.g., the SOPs) from the data sources 615. In some embodiments, the processing circuit 625 may retrieve SOPs that pertain to a given building. For example, the processing circuit 625 may retrieve SOPs that pertain to the building 10.

In some embodiments, the processing circuit 625 may transmit one or more API calls to retrieve information that pertains to one or more aspects of the building. For example, the processing circuit 625 may transmit one or more API calls to retrieve a floorplan of the building. As another example, the processing circuit 625 may transmit one or more API calls to receive an indication or identification of a digital twin of the building. The processing circuit 625 may ingest or otherwise add the retrieved information (e.g., the information obtained via the API calls) into the building management platform. The ingestion of the of the retrieved information may provide a context of the building. For example, by ingesting the floorplan of the building into the building management platform, the building management platform may execute one or more processes based on the floorplan. As another example, by ingesting a list of pieces of building equipment of the building, the building management platform may implement one or more control strategies based on the pieces of building equipment included in the building.

In some embodiments, the processing circuit 625 may retrieve the SOPs from the building systems 610. For example, the processing circuit 625 may receive, from the building systems 610, a list of SOPs associated with and/or integrated with a BMS. As another example, the processing circuit 625 may receive a list of SOPs integrated with given building systems and/or pieces of building equipment of the building systems 610. In some embodiments, the processing circuit 625 may retrieve information that indicates one or more statuses of SOPs. For example, the processing circuit 625 may retrieve information that indicates given SOPs integrated with a BMS. As another example, the processing circuit 625 may retrieve information that indicates a given number of SOPs currently active within a BMS. As even another example, the processing circuit 625 may retrieve information that indicates a given number of SOPs previously implemented within the BMS.

In some embodiments, the processing circuit 625 may generate one or more user interfaces. For example, the processing circuit 625 may transmit one or more signals to the user devices 620 to cause the user devices 620 to display (e.g., generate) a user interface. As another example, the processing circuit 625 may generate a user interface by providing various types of information to a display device. In some embodiments, the processing circuit 625 may generate the user interfaces by at least one of a web browser, a mobile application, and/or web page code. For example, the processing circuit 625 may interface with a web browser to cause the web browser to display a given web page (e.g., a user interface). As another example, the processing circuit 625 may cause a mobile application, stored on the user devices 620, to display a user interface.

In some embodiments, the user interfaces may include at least one graphical representation. For example, the user interfaces can include at least one of icons, input controls, navigation components, informational components, dropdowns, expandable portions, input fields, buttons, toggles, sliders, search fields, menus, and/or carousels. As another example, the graphical representations may include at least one of visual rendering, visual displays, and/or visual depictions of images (e.g., photos, videos, pictures, etc.). In some embodiments, the graphical representations may present information associated with one or more SOPs. For example, the user interface may include a first graphical representation and a second graphical representation.

In some embodiments, the first graphical representation may represent one or more SOPs. For example, the first graphical representation may indicate a given number of SOPs that are currently active in the building 10. Stated otherwise, the user interface may include informational components to present the given number of SOPS currently active in the building 10. In some embodiments, the second graphical representation may represent one or more SOPs. For example, the second graphical representation may indicate a given number of SOPs previously created for the building 10. Stated otherwise, the second graphical representation may include a list of SOPs that have been created for the building 10.

In some embodiments, the processing circuit 625 may receive one or more indications. For example, the processing circuit 625 may receive an indication of a selection. The selection may indicate an interaction with an element of a user interface. For example, the selection may indicate that a given portion (e.g., element) of the user interface was interfaced with and/or engaged. In some embodiments, the element (e.g., selected portion) may correspond to creating new SOPs. Stated otherwise, selection of the element may provide an indication to create a new SOP for the building 10. For example, an operator of the user device 620 may select the element to cause the user interface to include an area to create a new SOP for the building 10.

In some embodiments, the processing circuit 625 may update the user interface. For example, the processing circuit 625 may update the user interface responsive to and/or in accordance with one or more interactions (e.g., selections) with elements of the user interface. The processing circuit 625 may update the user interface by replacing, relocating, adding, removing, and/or otherwise changing the user interface. For example, the processing circuit 625 may update the user interface to include information associated with and/or indicated by one or more interactions with the user interface. In some embodiments, the processing circuit 625 may update the user interface by replacing a first graphical representation with a second graphical representation. For example, the processing circuit 625 may update the user interface to replace a list of current SOPs (e.g., a first graphical representation) with an area to create one or more new SOPs (e.g., a second graphical representation).

In some embodiments, the processing circuit 625 may update the user interface to include one or more areas. For example, the processing circuit 625 may update the user interface to include an area to create a new SOP. The area may receive one or more interactions to create the new SOP. For example, an operator of the user device 620 may place or otherwise locate (e.g., interactions) items and/or graphics within the area to create the new SOP.

In some embodiments, the area may include or otherwise indicate the items or graphics. For example, the area may include a window or bar that houses the items and/or graphics. As another example, the area may include a message or text box to indicate and/or identify the items and/or graphics. In some embodiments, the processing circuit 625 may update the user interface to include the area by displaying a list of items. For example, the processing circuit 625 may update the user interface to include graphical representations of the list of items. The user interface may include an indication that one or more items of the list of items may be placed in the area to define one or more aspects of the new SOP. For example, the user interface may include a message (e.g., an indication) that linking a first item with a second item may produce a given response. As another example, the user interface may include an animation or visual image that previews moving and/or placing given items within the area. Stated otherwise, the user interface may display a video that illustrates how to interact with the area to create a new SOP.

In some embodiments, the processing circuit 625 may store information associated with one or more interactions. For example, the processing circuit 625 may store information in the data sources 615. As another example, the processing circuit 625 may store information in one or more databases accessible to the processing circuit 625. In some embodiments, the processing circuit 625 may store information associated with interactions to create a new SOP. For example, the interactions to create the new SOP may include linking, pairing, and/or otherwise associated one or more items and/or graphics to indicate actions and/or elements of the new SOP. The processing circuit 625 may store the items and/or graphics in a given pattern to create the new SOP. For example, the processing circuit 625 may store the new SOP as a data structure to provide for retrieval of the new SOP. In some embodiments, the processing circuit 625 may create the new SOP by storing and/or responsive to storing the information associated with the interactions.

In some embodiments, the processing circuit 625 may receive information from the building systems 610. For example, the processing circuit 625 may receive information, from the building systems 610, that indicates current operating conditions of the building 10. As another example, the processing circuit 625 may receive information that represents timeseries data produced and/or collected by pieces of building equipment of the building 10. In some embodiments, the processing circuit 625 may receive information that represents one or more events of the building 10. For example, the processing circuit 625 may receive information that represents one or more door-forced-open (DFO) events. As another example, the processing circuit 625 may receive information that represents one or more start-up cycles for pieces of equipment. As another example, the processing circuit 625 may receive information that represents interactions with an ID scanner (e.g., a Quick Response (QR) code reader, a Radio Frequency Identification (RFID) scanner, a Near Field Communication (NFC) scanner, etc.) to provide access to the building 10.

In some embodiments, the processing circuit 625 may detect one or more changes in statuses of a building. For example, the processing circuit 625 may detect that a number of DFO events exceeds a predetermined threshold. As another example, the processing circuit 625 may detect that a number of attempts to gain access to the building 10 exceeds a predetermined threshold. As another example, the processing circuit 625 may detect a change in the status of the building based on one or more criteria defined by given SOPs for the building 10. In some embodiments, the processing circuit 625 may detect one or more events associated with the building 10. For example, the processing circuit 625 may detect an unauthorized entrance (e.g., an intrusion event) within the building 10. As another example, the processing circuit 625 may detect an equipment fault (e.g., an equipment event). As another example, the processing circuit may detect an interaction with an alarm (e.g., a fire alarm event, a flood alarm event, etc.). In some embodiments, the processing circuit 625 may detect one or more events responsive to detecting that an amount of time (since a previous testing routine) has exceeding one or more thresholds. For example, the processing circuit 625 may detect a maintenance event responsive to an amount since a piece of equipment underwent maintenance exceeding a threshold.

In some embodiments, the processing circuit 625 may detect that the change in the status of the building 10 includes an implementation of a given SOP. For example, given events and/or a given number of events may cause the processing circuit 625 to implement, execute, or otherwise perform one or more actions of an SOP. A given SOP may be linked and/or associated with the events such that detection of a change in the status of the building based on the events may trigger implementation of the given SOP or one or more steps of the SOP.

In some embodiments, the processing circuit 625 may update the user interface to include an indication of the change in the status. For example, the processing circuit 625 may cause the user interface to include a banner or message that provides an indication of the change in the status. As another example, the processing circuit 625 may update the user interface to display an alert to identify a given SOP. In some embodiments, the processing circuit 625 may cause a given user device 620 to display the user interface with the indication of the change in the status. For example, the given SOP, included in the change in the status, may identify or indicate a given persona to implement the SOP. The processing circuit 625 may cause a given user device 620, associated with the given persona, to display the indication of the change in the status.

In some embodiments, the processing circuit 625 may detect that a change in the status of the building triggers an automated implementation of a given SOP. For example, the given SOP may include a statement or rule that defines given actions to automatically implement to address the change in the status of the building. In some embodiments, processing circuit 625 may automatically implement the given SOP based on detection of a change in the status that triggers the given SOP. For example, a given SOP may include a rule to indicate that detection of a number of DFO events within a given amount of time triggers automatic implementation of the given SOP.

In some embodiments, the processing circuit 625 may monitor, analyze, process, or otherwise review an event stream. For example, as events occur or corresponding data is produced by the building 10 or one or more devices thereof, the processing circuit 625 may receive, via the event stream, the data. Upon receipt or during a continuous stream of data, the processing circuit 625 may detect one or more events or occurrences of events. For example, a DFO occurrence may trigger the production or distribution one or more data strings via the event stream. The processing circuit 625 may detect, via the event stream, the DFO occurrence. In some embodiments, the processing circuit 625 monitoring the event stream for one or more events may represent an initial step or a trigger to implement subsequent steps or actions of the SOP.

In some embodiments, the processing circuit 625 may cause the building systems 610 to perform one or more actions. For example, the processing circuit 625 may transmit control signals to the building systems 610 to control various operations of the building systems 610. In some embodiments, the processing circuit 625 may cause the building systems 610 to perform the one or more actions responsive to detection of the change in the building that triggers automatic implementation of a given SOP. For example, the processing circuit 625 may cause the building systems 610 to perform given actions indicated by the given SOP.

In some embodiments, the processing circuit 625 may cause the building systems 610 to perform actions that include at least one displaying an alert to indicate the change in the status, updating a user interface to indicate the change in the status, and/or controlling one or more pieces of building equipment. For example, the processing circuit 625 may transmit signals to the building systems 610 to cause the building systems 610 control one or more pieces of building equipment. As another example, the building 10 may include a monitor in a lobby of the building 10. In this example, the processing circuit 625 may cause the monitor to display an alert to indicate the change in the status of the building 10. In some embodiments, the processing circuit 625 may implement one or more actions such as controlling lighting equipment to illuminate a zone or space of the building 10. The processing circuit 625 may implement one or more actions such as transmitted one or more push notification or alerts to devices.

In some embodiments, one or more SOPs may include a list of actions. For example, a given SOP may indicate one or more actions to perform responsive to detection of an event and/or criteria that triggers implementation of the given SOP. As another example, a given SOP may indicate that when a given piece of equipment fails that actions be performed to address the failure. In some embodiments, the processing circuit 625 may receive information from the building systems 610 that indicates performance of one or more actions for a given SOP. For example, the processing circuit 625 may receive, from the building systems 610, an indication that power has been shut off to a given part of the building 10. As another example, the processing circuit 625 may receive information to indicate that a given door of the building 10 has been locked. As even another example, the processing circuit 625 may receive information that a given piece of equipment has been reset and/or restarted.

In some embodiments, the processing circuit 625 may update a user interface to provide an indication of performance of given actions. For example, the processing circuit 625 may update a user interface to indicate when given actions for an SOP have been performed. As another example, the processing circuit 625 may update the user interface to reflect information provided by the building systems 610. Stated otherwise, the processing circuit 625 may update the user interface to indicate performances of given actions based on information provided by the building systems 610.

In some embodiments, the processing circuit 625 may receive indications of given selections within the user interface. For example, the processing circuit 625 may receive an indication of a selection of a given SOP that is currently active in the building 10. Stated otherwise, the processing circuit 625 may receive an indication of a selection of an SOP that is currently being implemented in the building. In some embodiments, the processing circuit 625 may update the user interface to include a list of actions associated with implementation of the selected SOP. For example, the processing circuit 625 may update the user interface to include an overlay or a banner that presents the list of actions. As another example, the processing circuit 625 may update the user interface to display a window that includes the list of actions. In some embodiments, the processing circuit 625 may update the user interface include indications of actions previously performed. For example, the processing circuit 625 may update the user interface to include a list of actions associated with a given SOP and further indicate which actions have been previously performed.

In some embodiments, the processing circuit 625 may receive an indication of a selection of a SOP that was previously created for the building 10. The processing circuit 625 may update the user interface to include a list of items associated with the selected SOP. For example, the processing circuit 625 may update the user interface to display a given arrangement of the items to indicate interactions user to create the SOP. Stated otherwise, the processing circuit 625 may retrieve, from the data sources 615, information that represents interactions with the area of the user interface to create the SOP. In some embodiments, the processing circuit 625 may update the user interface to include the list of items by placing one or more items in given locations of the user interface to indicate of the items are associated with one another.

In some embodiments, the processing circuit 625 may update the user interface to include graphical representations that indicate SOP previously implemented in the building 10. For example, the processing circuit 625 may update the user interface to include a list of SOPs that have been implemented within a given time period. In some embodiments, the processing circuit 625 may update the graphical representations responsive to detection of a subsequent implementation of a given SOP within the building 10. The processing circuit 625 may cause the user interface to include indications of outcomes that resulted from implementation of the SOPs. For example, the processing circuit 625 may update the user interface to indicate an event that triggered a given SOP as well as whether the event was addressed based on implementation of the given SOP. As another example, the processing circuit 625 may update the user interface to include an outcome (e.g., response) of given SOP that was implemented to address a given event.

In some embodiments, the processing circuit 625 may receive an indication of a selection to display a given SOP. The given SOP may be pending or awaiting approval. For example, prior to implementation of the given SOP within a BMS, the given SOP may be considered pending. As another example, a given SOP may be implemented within a BMS responsive to approval of the given SOP by one or more entities. In some embodiments, the processing circuit 625 may update the user interface to include indications of SOPs awaiting approval. The selection to display the given SOP may be a selection of an SOP awaiting approval.

In some embodiments, the processing circuit 625 may update the user interface to include a graphical representation to display a list of actions to perform the SOP that is awaiting approval. For example, the processing circuit 625 may update the user interface to display given arrangements of items used to create the SOP that is awaiting approval. As another example, the processing circuit 625 may update the user interface to display a list of actions for the building system 610 to perform to implement the SOP.

In some embodiments, the processing circuit 625 may integrate one or more SOPs responsive to receipt of indications to accept the SOPs. For example, the processing circuit 625 may integrate a given SOP by adding the given SOPs to a list of SOPs available for the building 10. As another example, the processing circuit 625 may integrated the given SOPs by updating the user interface to include an indication that the given SOP may be implemented within the building 10. In some embodiments, the processing circuit 625 may receive indications to accept the SOPs responsive to the SOPs having been approved. For example, the processing circuit 625 may receive indications to accept one or more SOPs that has been awaiting approval.

In some embodiments, the various SOPs described herein may correspond to and/or be associated with one or more aspects of the building 10. For example, one or more SOPs may be associated with a lighting system of the building 10. As another example, the one or more SOPs may be associated with intrusion alerts of the building 10. As another example, the one or more aspects of the building 10 may be associated with or represent one or more previously detected faults. In some embodiments, the lighting system may be included in the building systems 610. In some embodiments, the lighting system may include light sources (e.g., Light Emitting Diodes (LEDs), lighting devices, light fixtures, etc.). The lighting system may include emergency lighting, such as emergency exit signs.

In some embodiments, the integration or inclusion of the SOPs within a BMS or building system can advantageously utilize information associated with one or more building subsystems. For example, the processing circuit 625 may integrate SOPs with a BMS such that criteria, triggers, or constraints for detection of one or more events (of a building) may rely on or otherwise utilize information from multiple systems of the building. In some embodiments, the integration of SOPs with the BMS provides for criteria that utilizes information associated with lighting equipment (of a lighting system) along with information associated with access points (of a building security system) or recording devices (e.g., cameras). Stated otherwise, the integration of the SOPs with the BMS provides for utilization of datasets or data constraints associated with or otherwise produced by multiple or discrete systems of a building.

In some embodiments, implementation of SOPs associated with the lighting system may include generating alerts or warnings to indicate given light fixtures that have not been serviced. For example, the processing circuit 625 may monitor or track service logs for one or more light fixtures of the lighting system. The processing circuit 625 may implement one or more given SOPs responsive to detecting that an amount of time since servicing a given light fixture exceeds a predetermined threshold.

In some embodiments, implementation of SOPs associated with intrusion alert may include generating alerts or warnings to indicate a potential intrusion within the building 10. For example, the processing circuit 625 may detect one or more DFO events that indicate a potential intrusion. The processing circuit 625 may implement one or more SOPs responsive to the detection of the potential intrusion.

### User Interfaces

In some embodiments, the processing circuit 625 may display and/or cause one or more devices to display at least one of the various user interfaces described herein. The various user interfaces described herein may be presented and/or displayed within a web browser and/or a mobile application. In some embodiments, the various user interfaces described herein may be presented as one or more user interfaces. For example, the various user interfaces described herein may be presented as a single user interface with scrolls or various navigation components. As another example, the various user interfaces described herein may be presented as standalone user interfaces that are updated and/or replaced.

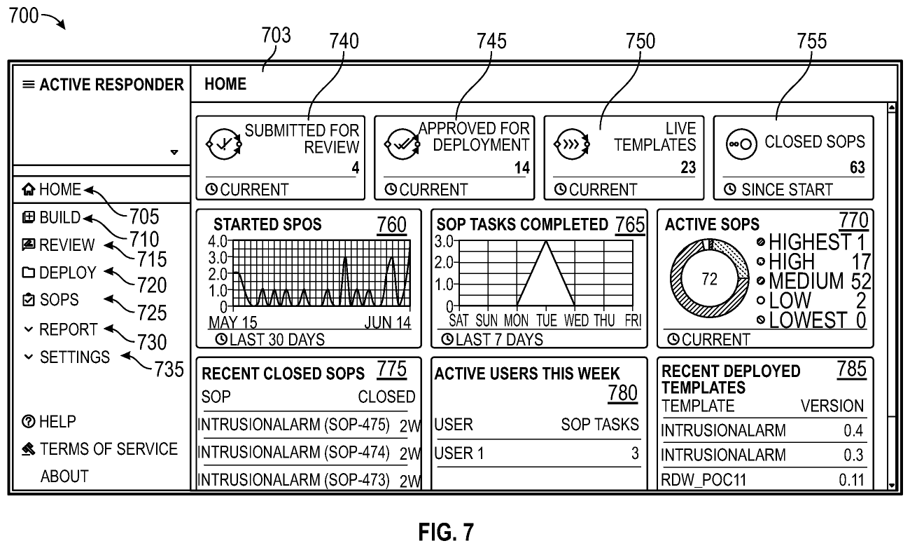

FIG. 7 depicts a user interface 700, according to some embodiments. In some embodiments, the processing circuit 625 may generate the user interface 700. For example, the processing circuit 625 may cause the user devices 620 to display the user interface 700. In some embodiments, the user interface 700 may include at least one of cards, information components, and/or text boxes. For example, the user interface 700 is shown to include cards 740, 745, 750, 755, 760, 765, 770, 775, 780, and 785. In some embodiments, the various cards of the user interface 700 may refer to and/or include at least one of the various graphical representations of SOPs described herein. For example, the card 740 is shown to indicate a number of SOPs submitted for review. As another example, the card 770 is shown to indicate SOPs that are currently active.

As shown in FIG. 7, the user interface 700 includes interface portion 703. The interface portion 703 may refer to and/or include an updatable and/or replaceable portion of the user interface 700. For example, the interface portion 703 may be replaced and/or substituted for a subsequent interface portion. As another example, the interface portion 703 may be updated to display subsequent and/or different information to the information illustrated in FIG. 7. In some embodiments, selection of at least one card of the user interface 700 may cause the interface portion 703 to be updated. For example, selection of the card 775 and/or an SOP included in the card 775 may cause the interface portion 703 to be replaced with information associated with a selected SOP.

In some embodiments, the user interface 700 may include at least one of buttons, checkboxes, toggles, and/or dropdowns. For example, as shown in FIG. 7, the user interface 700 includes buttons 705, 710, 715, 720, 725, 730, and 735. In some embodiments, selection of a given button of the user interface 700 may cause the interface portion 703 to be updated and/or otherwise replaced. For example, selection of the button 705 may cause the user interface 700, as shown in FIG. 7, to be displayed. As another example, selection of the button 710 may cause the interface portion 703 to be replaced with an area to build (e.g., create) one or more SOPs. As another example, selection of the button 715 may cause the interface portion 703 to be updated with a list of SOPs awaiting approval. As another example, selection of the button 720 may cause the interface portion 703 to be updated with a list of SOPs awaiting deployment (e.g., integration) within a BMS. As another example, selection of the button 725 may cause the interface portion 703 to be updated with a list of SOPs currently implemented within a BMS. As another example, selection of the button 730 may cause the interface portion 703 to be updated with reports and/or performance of one or more given SOPs. As another example, selection of the button 735 may cause the interface portion 703 to be updated with information corresponding to various SOPs.

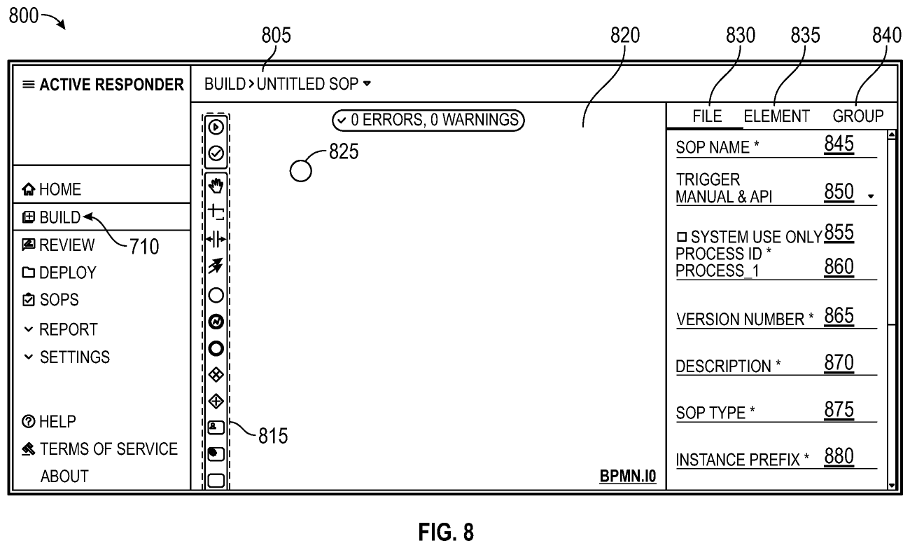

FIG. 8 depicts a user interface 800, according to some embodiments. In some embodiments, the user interface 800 may be displayed and/or presented responsive to selection of the button 710. For example, the processing circuit 625 may present the user interface 800 by replacing and/or updating the interface portion 703 with interface portion 805. In some embodiments, the interface portion 805 and/or one or more portions thereof may refer to and/or include the area to create one or more SOPs. For example, the interface portion 805 is shown to include area 820. The area 820 may receive or accept one or more items 825. Additionally, the area 820 may include a list of items 815. In some embodiments, placement and/or position of the items 825 within the area 820 may create or define one or more SOPs. In some embodiments, the interface portion 805 may include tabs 830, 835, and 840. The tabs may include or represent input fields. For example, the tab 830 is shown to include inputs fields 845, 850, 855, 860, 865, 870, 875, and 880.

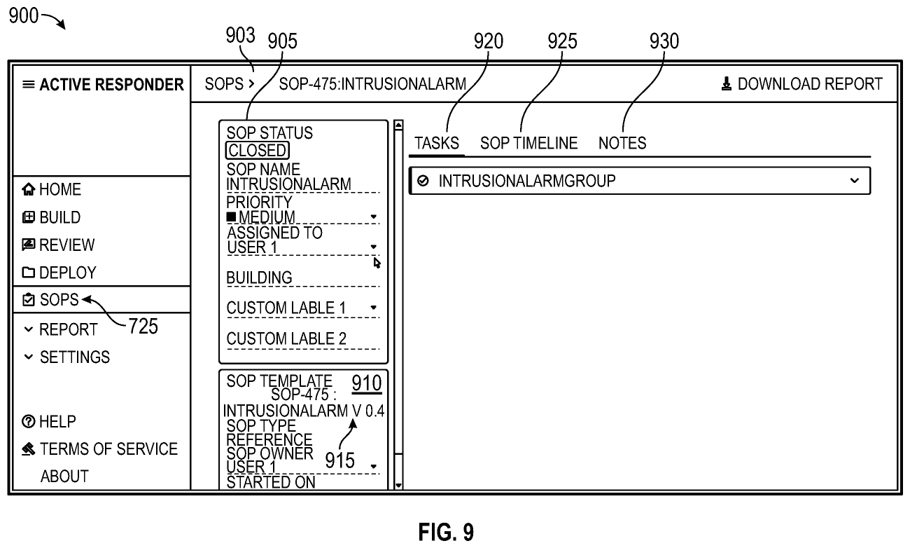

FIG. 9 depicts a user interface 900, according to some embodiments. In some embodiments, the user interface 900 may be displayed and/or presented responsive to selection of at least one of the button 725, the card 775, and/or one or more SOPs included in the card 775. As shown in FIG. 9, the user interface 900 includes interface portion 903. In some embodiments, the processing circuit 625 may update and/or present the user interface 900 by replacing the interface portion 703 with the interface portion 903. As shown in FIG. 9, the interface portion 903 includes information associated with a given SOP. For example, the interface portion 903 includes cards 905 and 910. The interface portion 903 is also shown to include tabs 920, 925, and 930. In some embodiments, the card 905 may provide a status of the given SOP. For example, as shown in FIG. 9, the SOP is shown as closed (e.g., completed, previously implemented, etc.). In some embodiments, the card 910 may include a link 915. The processing circuit 625 may update the interface portion 903 to include additional information associated with the SOP responsive to selection of the link 915.

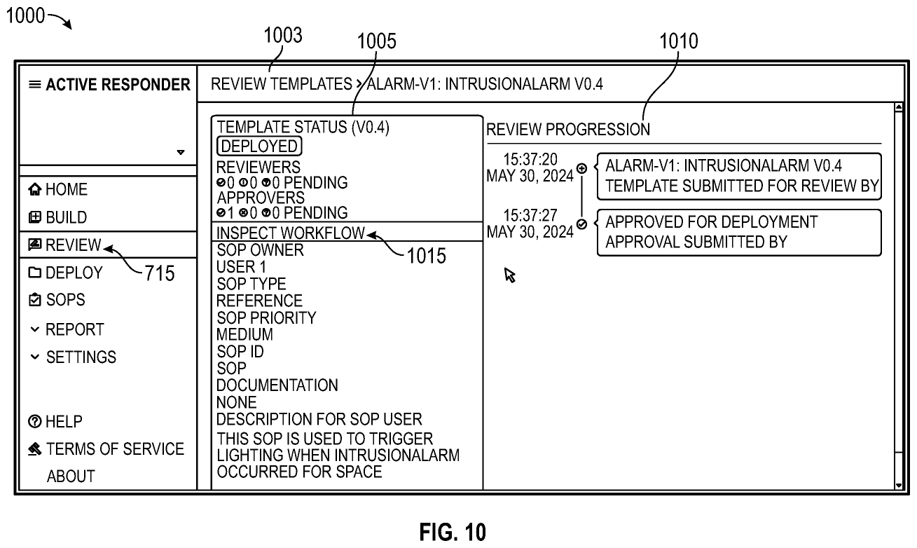

FIG. 10 depicts a user interface 1000, according to some embodiments. In some embodiments, the user interface 1000 may be generated and/or presented responsive to selection of the link 915. As shown in FIG. 10, the user interface 1000 includes interface portion 1003. The interface portion 1003 is shown to include cards 1005 and 1010. In some embodiments, the card 1005 may include a link 1015 to inspect and/or review a given SOP. The card 1010 may indicate and/or present a timeline associated with the given SOP.

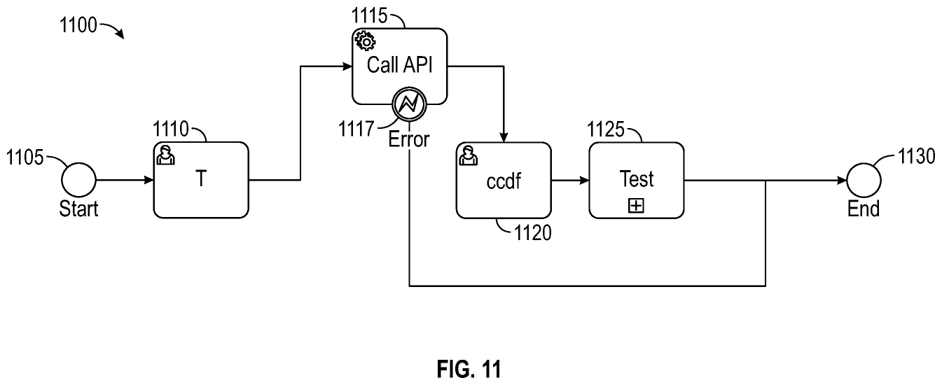

FIG. 11 depicts a user interface 1100, according to some embodiments. In some embodiments, the user interface 1100 may be generated and/or presented responsive to selection of the link 1015. As shown in FIG. 11, the user interface 1100 includes items 1105, 1110, 1115, 1117, 1120, 1125, and 1130. The items are shown to have a given arrangement or order to illustrate or indicate interactions that created and/or defined the SOP. For example, the user interface 1100 may illustrate a given order or pattern of actions to perform to implement the SOP.

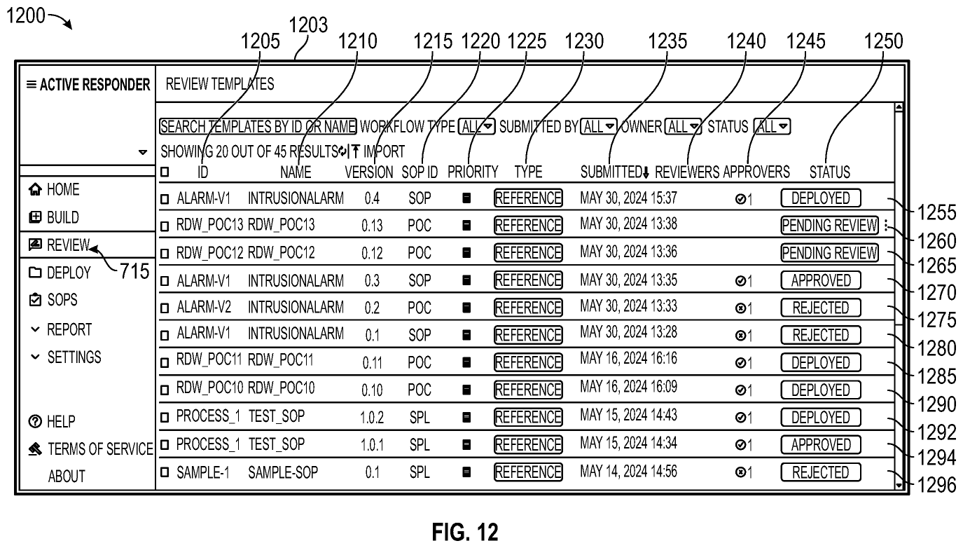

FIG. 12 depicts a user interface 1200, according to some embodiments. In some embodiments, the user interface 1200 may be generated and/or presented responsive to selection of the button 715. In some embodiments, the user interface 1200 may include interface portion 1203 to present information associated with one or more SOPs. For example, the interface portion 1203 is shown to include entries 1255, 1260, 1265, 1270, 1275, 1280, 1285, 1290, 1292, 1294, and 1296 to represent one or more SOPs. As shown in FIG. 12, the interface portion 1203 includes columns 1205, 1210, 1215, 1220, 1225, 1230, 1235, 1240, 1245, and 1250 to identify given information for various entries. For example, the column 1205 provides an indication of an ID for given entries (e.g., SOPs). As another example, the column 1250 provides an indication of a status for given entries.

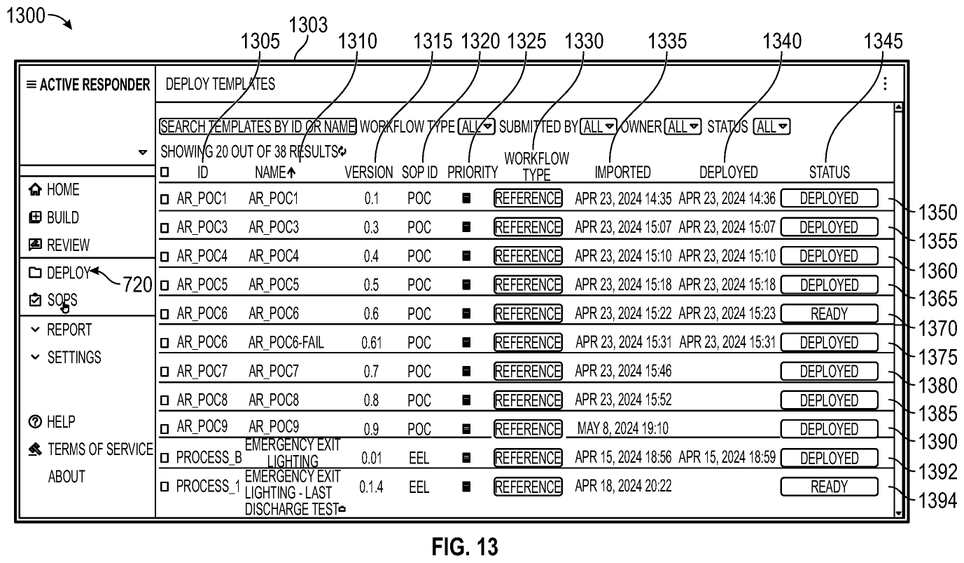

FIG. 13 depicts a user interface 1300, according to some embodiments. In some embodiments, the user interface 1300 may be generated and/or presented responsive to selection of the button 720. As shown in FIG. 13, the user interface 1300 includes interface portion 1303. In some embodiments, the interface portion 1303 may include entries 1350, 1355, 1360, 1365, 1370, 1375, 1380, 1385, 1390, 1392, and 1394 to represent one or more SOPs. As shown in FIG. 13, the interface portion 1303 includes columns 1305, 1310, 1315, 1320, 1325, 1330, 1335, 1340, and 1345 to identify given information for various SOPs represented by the entries. In some embodiments, the user interface 1300 may include a list of SOPs deployed and/or integrated within a BMS. Stated otherwise, the interface portion 1303 may display a list of SOPs that have been approved and integrated within the BMS.

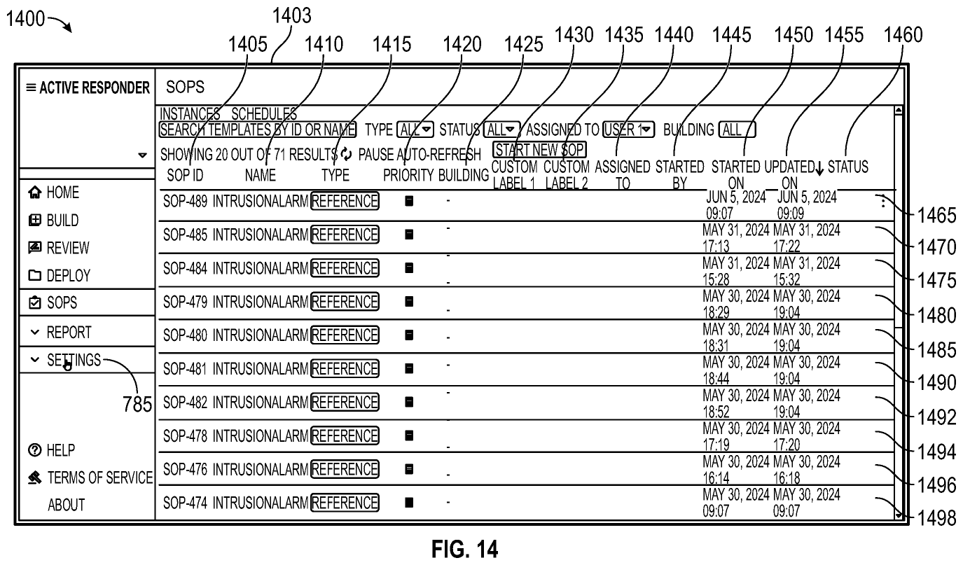

FIG. 14 depicts a user interface 1400, according to some embodiments. In some embodiments, the user interface 1400 may be generated and/or presented responsive to selection of at least one of the buttons 725, 730, and/or 735. As shown in FIG. 14, the user interface 1400 includes interface portion 1403. In some embodiments, the interface portion 1403 may include entries 1465, 1470, 1475, 1480, 1485, 1490, 1492, 1494, 1496, and 1498 to represent one or more SOPs. As shown in FIG. 14, the interface portion 1403 includes columns 1405, 1410, 1415, 1420 1425, 1430, 1435, 1440, 1445, 1450, 1455, and 1460 to identify given information for one or more of the entries included in the user interface 1400. In some embodiments, the user interface 1400 may represent an overview or summary of one or more SOPs for a BMS.

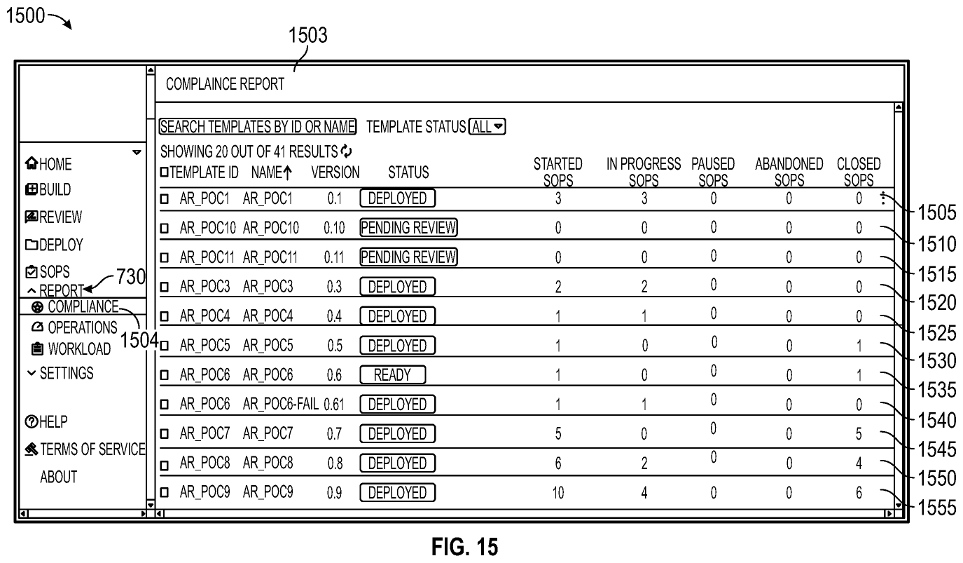

FIG. 15 depicts a user interface 1500, according to some embodiments. In some embodiments, the user interface 1500 may be generated and/or presented responsive to selection of the button 730. As shown in FIG. 15, the user interface 1500 includes interface portion 1503. The interface portion 1503 may include entries 1505, 1510, 1515, 1520, 1525, 1530, 1535, 1540, 1545, 1550, and 1555 to represent one or more SOPs. In some embodiments, the user interface 1500 may display information to view one or more reports or information associated with the SOPs. For example, the interface portion 1503 may display information to indicate a number of occurrences and/or implementations for a given SOP. As another example, the interface portion 1503 may display information to indicate a number of updates or adjustments (e.g., versions) for a given SOP.

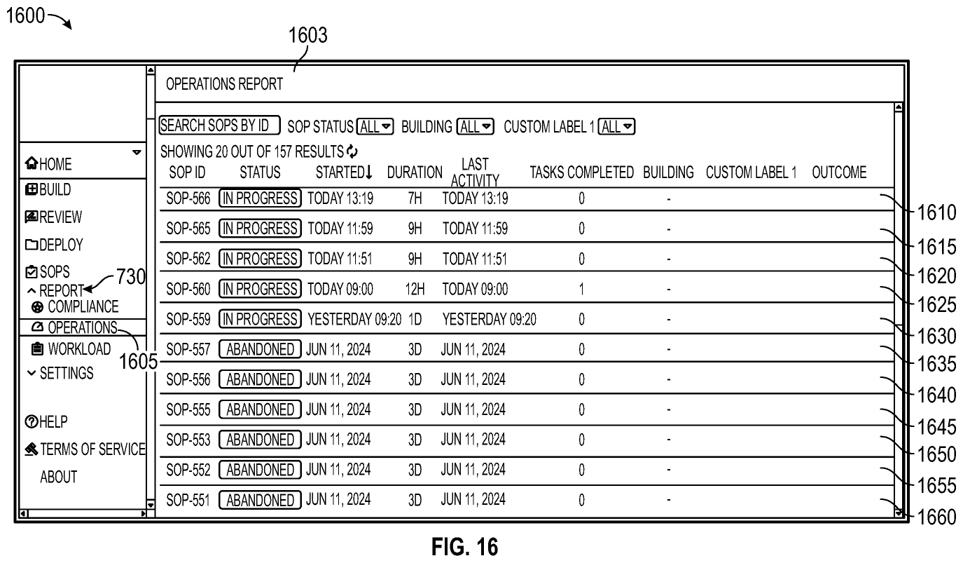

FIG. 16 depicts a user interface 1600, according to some embodiments. In some embodiments, the user interface 1600 may be generated and/or presented responsive to selection of button 1605. As shown in FIG. 16, the user interface 1600 includes interface portion 1603. In some embodiments, the user interface 1600 may include entries 1610, 1615, 1620, 1625, 1630, 1635, 1640, 1645, 1650, 1655, and 1660 to represent statuses of one or more SOPs. For example, the interface portion 1603 may display information to indicate a timeline of when given SOPs were implemented and/or performed. As another example, the interface portion 1603 may include indications of whether a given SOP is deployed (e.g., integrated) within a BMS.

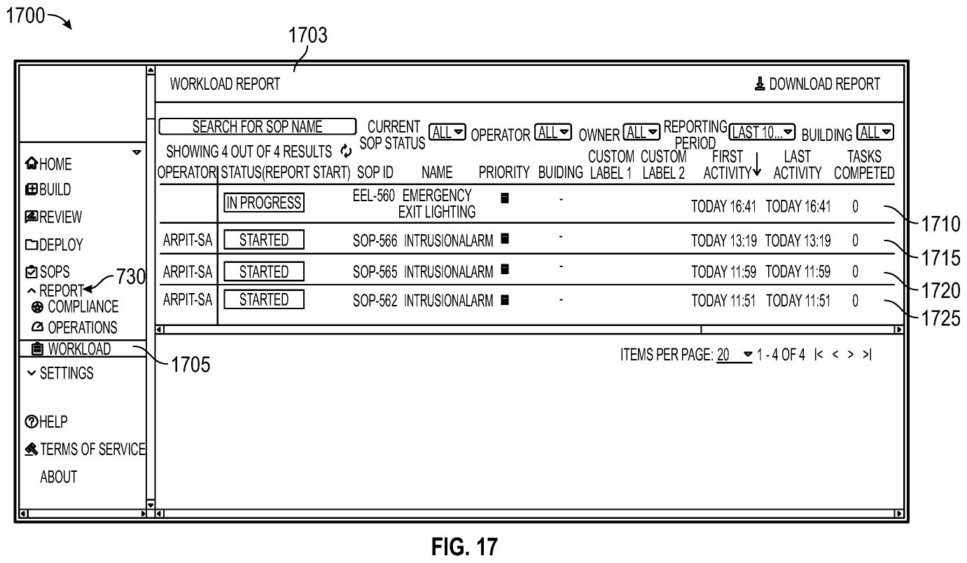

FIG. 17 depicts a user interface 1700, according to some embodiments. In some embodiments, the user interface 1700 may be generated and/or presented responsive to selection of button 1705. As shown in FIG. 17, the user interface 1700 includes interface portion 1703. In some embodiments, the interface portion 1703 may include entries 1710, 1715, 1720, and 1725 to indicate given operators and/or technicians that may be monitoring and/or implementing one or more actions for a given SOP.

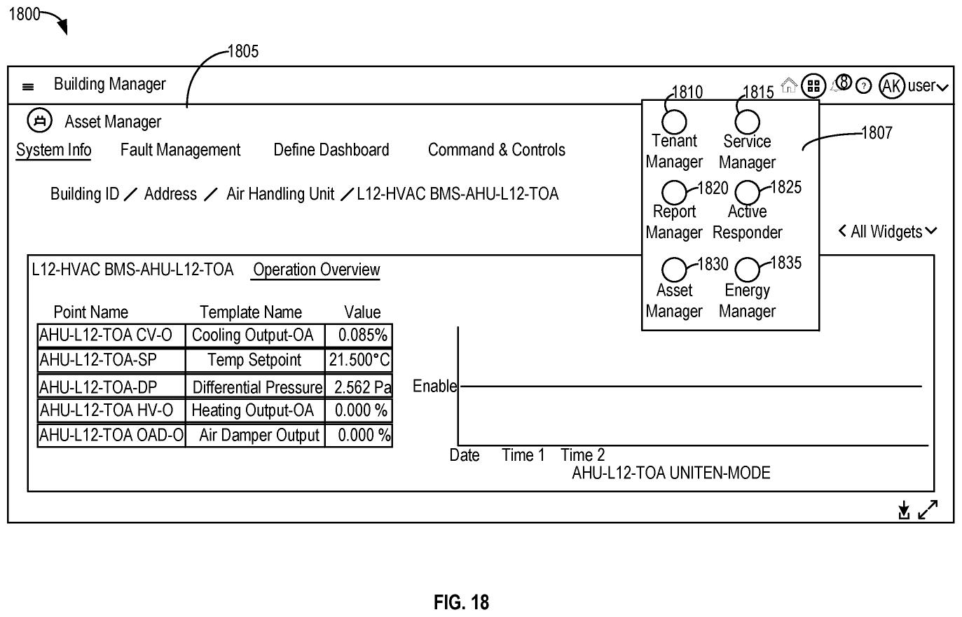

FIG. 18 depicts a user interface 1800, according to some embodiments. In some embodiments, the user interface 1800 may be integrated with and/or interface with a BMS. For example, the user interface 1800 may be integrated with the BMS 400. In some embodiments, the user interface 1800 may provide access to one or more platforms of a BMS. For example, the user interface 1800 may provide access to Command and Controls for a building (e.g., a platform). As another example, the user interface 1800 may provide access to an energy manager for a building (e.g., a platform). In some embodiments, the user interface 1800 may provide access to one or more platforms of a BMS by presenting information associated with the platforms. For example, the user interface 1800 may include information to identify current energy consumption information for a building. As another example, the user interface 1800 may include information to identify a current number of pieces of equipment experiences faults. In some embodiments, the user interface 1800 may provide a gateway to the platforms of the BMS. For example, a selection of a given icon, on the user interface 1800, may cause a given action to be performed by the platforms of the BMS.

In some embodiments, the user interface 1800 may include at least one window (shown as interface portion 1805). The interface portion 1805 may be associated with a given platform for a BMS. For example, as shown in FIG. 18, the interface portion 1805 is shown associated with an asset manager platform for a BMS. In some embodiments, the user interface 1800 may include a menu 1807. For example, the menu 1807 may be presented as a dropdown or overlay within the user interface 1800. In some embodiments, the menu 1807 may include at least one element. For example, in FIG. 18, the user interface 1800 is shown to include elements 1810, 1815, 1820, 1825, 1830, and 1835. In some embodiments, the elements may be associated with a given platform of the BMS. For example, the element 1820 is shown to be associated with a report manager platform of the BMS. As another example, the element 1830 is shown to be associated with the asset manager platform of the BMS.

In some embodiments, the menu 1807 and/or one or more elements thereof may be presented via and/or included in at least one of the user interfaces described herein. For example, the user interface 700 may include the menu 1807. In some embodiments, at least one of the user interfaces described herein may be generated and/or displayed responsive to selection of at least one element. For example, the user interface 1800 may be displayed responsive to selection of the element 1830. As another example, the user interface 700 may be displayed responsive to selection of the element 1825 (which is shown associated with an active responder platform in FIG. 18).

In some embodiments, the building integrator 605 may provide one or more platforms. For example, the building integrator 605 may provide a building management platform by generating one or more user interfaces. As another example, the building integrator 605 may provide the building management platform by serving as a gateway between one or more computing devices and a BMS of the building. Stated otherwise, the building integrator 605 may provide access and/or control to one or more functions of the BMS. In some embodiments, the building management platform may monitor and control one or more aspects of the building. For example, the building management platform may implement Command and Control functions for a building. As another example, the building management platform may interface with the building systems 610.

In some embodiments, the building management platform may retrieve and/or utilize information collected by and/or maintained by one or more platforms, subsystems, and/or functions of the building. For example, the building management platform may retrieve information from a first building system 610 to generate one or more standard operating procedures. As another example, the building management platform may control one or more building systems 610 based on criteria and/or rules established by one or more standard operating procedures for the building.

In some embodiments, the one or more functions of the BMS may include controlling and/or monitoring one or more aspects of the building. For example, the one or more functions may include providing temperature control for the building (e.g., an aspect). As another example, the one or more functions may include providing building entry monitoring by monitoring interactions with an access control system of the building (e.g., an aspect).

In some embodiments, the building integrator 605 may provide the building management platform by generating at least one of the user interfaces described herein. For example, the building integrator 605 may provide the building management platform by generating the user interface 1800. In some embodiments, the building integrator 605 may generate the user interfaces to provide access to a standard operating procedure function. For example, the building integrator 605 may generate the user interface 800 to provide access to the area 820 to create a standard operating procedure (e.g., a standard operating procedure function). As another example, the building integrator 605 may generate the user interface 700 to provide a dashboard that includes information to identify a status of one or more standard operating procedures for the building (e.g., a standard operating procedure function).

In some embodiments, the building integrator 605 may detect one or more interactions with an area of a user interface. For example, the building integrator 605 may detect a placement of the item 825 within the area 820. As another example, the building integrator 605 may detect a selection of a given item within the list of items 815. In some embodiments, the interactions may include indications of one or more actions for a standard operating procedure. For example, the interactions may indicate a given piece of information to retrieve (e.g., an action). As another example, the interactions may indicate one or more pieces of building equipment to control.

In some embodiments, the building integrator 605 may determine whether to initiate an instance of a standard operating procedure. For example, the building integrator 605 may determine whether to perform one or more actions included in a standard operating procedure. As another example, the building integrator 605 may determine whether to retrieve a given piece of equipment. In some embodiments, the building integrator 605 may obtain data from one or more of the functions of the building management platform to determine whether to initiate an instance of the standard operating procedure. For example, the building integrator 605 may retrieve information from an asset health agent (e.g., a function) that indicates maintenance records for one or more pieces of equipment of the building. As another example, the building integrator may retrieve information from an access control system (e.g., a function) to monitor entrances and/or exits from the building.

In some embodiments, the building integrator 605 may obtain information based on criteria and/or rules indicated by one or more standard operating procedures. For example, a given standard operating procedure may include rules that indicate given information to retrieve to determine when to perform a given action. As another example, the given standard operating procedure may identify given maintenance records to retrieve to perform one or more subsequent actions of the standard operating procedure.

In some embodiments, the building integrator 605 may determine that one or more items have been linked to one or more another within a user interface. For example, the building integrator 605 may determine that a first item 825 is linked with a second item 825. In some embodiments, the building integrator 605 may determine links between items based on a placement of items within an area. For example, the building integrator 605 may determine that the first item 825 and the second item 825 were placed in the area 820. In some embodiments, at least one of the items placed in the area may identify one or more aspects of a standard operating procedure. For example, a first item 825 may identify one or more pieces of information to retrieve from the BMS and/or one or more functions thereof. As another example, the first item 825 may identify criteria and/or rules that trigger retrieval of given pieces of information.

In some embodiments, the one or more items may identify one or more actions to perform. For example, a second item 825 may indicate given pieces of building equipment to control based on criteria (e.g., the first item 825) linked to the second item 825. As another example, the second item may indicate that one or more light fixtures be turned on responsive to detection of an intrusion (e.g., criteria).

In some embodiments, the building integrator 605 may integrate one or more standard operating procedures with the BMS. For example, the building integrator 605 may begin to retrieve given pieces of information based on a standard operating procedure. As another example, the building integrator 605 may control one or more pieces of building equipment based on a standard operating procedure.

In some embodiments, integration of one or more standard operating procedures may cause the building systems 610 to implement one or more automatic actions. For example, a given standard operating procedure may dictate that an alert is generated when a given light fixture has not been serviced within a predetermined amount of time. As another example, a given standard operating procedure may dictate that detection of an intrusion event, by an access control system of the building, triggers activation of a given light fixture.

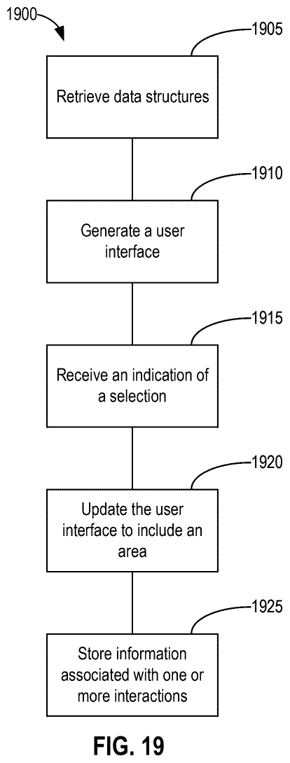

FIG. 19 depicts a flow diagram of a method 1900 to integrate SOPs with a BMS, according to some embodiments. In some embodiments, the method 1900 and/or one or more steps thereof may be implemented and/or performed by at least one of the various systems, devices, and/or components described herein. For example, the building integrator 605 may perform the method 1900. In some embodiments, the method 1900 and/or one or more steps thereof may be repeated, replaced, reproduced, alerted, modified, separated, omitted, and/or otherwise changed. While one or more steps of the method 1900 may have been described herein in a given order, this is for illustrative purposes only and is in no way limiting or indicative of how to implement the method 1900.

In some embodiments, at step 1905, one or more data structures may be retrieved. For example, the processing circuit 625 may retrieve one or more data structures from the data sources 615. In some embodiments, the data structures may represent one or more SOPs for a building and/or a BMS. For example, the data structures may represent SOPs for the building 10. As another example, the data structures may represent SOPs integrated with the BMS 400. In some embodiments, the processing circuit 625 may receive the data structures responsive to transmission of one or more API calls. The processing circuit 625 may process or otherwise ingest the data structures.

In some embodiments, at step 1910, a user interface may be generated. For example, the processing circuit 625 may generate a user interface to present the data structures retrieved in step 1905. As another example, the processing circuit 625 may generate a user interface to include a plurality of graphical representations to present information associated with one or more SOPs. In some embodiments, the processing circuit 625 may generate the user interface 700. For example, the processing circuit 625 may generate a user interface to include at least one of the cards (e.g., graphical representations) included in the user interface 700.

In some embodiments, the user interface may include a first graphical representation to indicate a first number of SOPs currently active in the building 10. For example, the user interface may include the card 770. In some embodiments, the user interface may include a second graphical representation to indicate a second number of SOPs previously created for the building 10. For example, the user interface may include the card 750.

In some embodiments, at step 1915, an indication of a selection may be received. For example, the processing circuit 625 may receive an indication of a selection within the user interface generated in step 1910. In some embodiments, the processing circuit 625 may receive the indication responsive to an operator of the user device 620 interacting with and/or interfacing with the user interface displayed via the user device 620.

In some embodiments, the processing circuit 625 may receive an indication of a selection of an element to create a new SOP. For example, the processing circuit 625 may receive an indication of a selection of the button 710. As another example, the processing circuit 625 may receive, via the user interface, a prompt to create a new SOP for the building 10.

In some embodiments, at step 1920, the user interface may be updated to include an area. For example, the processing circuit 625 may update the user interface 700 by replacing the interface portion 703 with the interface portion 805. As another example, the processing circuit 625 may replace the user interface 700 with the user interface 800. In some embodiments, the processing circuit 625 may update the user interface to include the area by transmitting one or more signals to the user device 620 to cause the interface portion 703 to be replaced with the interface portion 805 and/or the area 820. For example, the processing circuit 625 may transmit one or more signals to the user device 620 to redirect the user device 620 to different page and/or directory of a website. As another example, the processing circuit 625 may transmit one or more signals to the user device 620 to cause the user device to display a given page within a mobile application.

In some embodiments, at step 1925, information associated with one or more interactions may be stored. For example, the processing circuit 625 may store information associated with interactions with the area 820. As another example, the processing circuit 625 may store information that represents given arrangements of items in the area 820. In some embodiments, processing circuit 625 may store the information in the data sources 615. For example, the processing circuit 625 may transmit one or more API pushes to provide the information to the data sources 615. In some embodiments, the processing circuit 625 may store the information associated with the interactions to create a given SOP. For example, the interactions may represent criteria and/or actions associated with the given SOP. The given SOP may be created responsive to storing a record (e.g., information) of the given SOP.

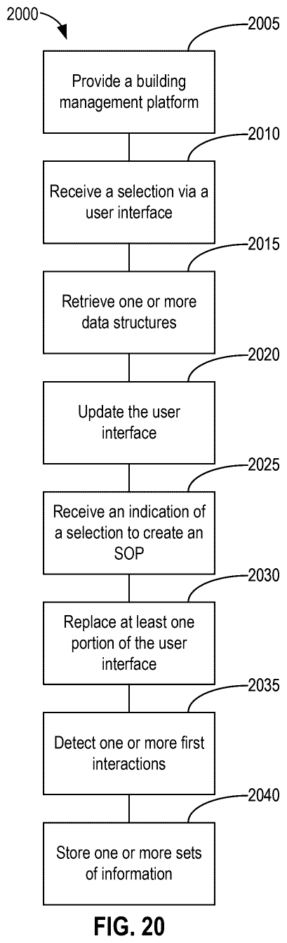

FIG. 20 depicts a flow diagram of a method 2000 to create one or more SOPs, according to some embodiments. In some embodiments, the method 2000 and/or one or more steps thereof may be implemented and/or performed by at least one of the various systems, devices, and/or components described herein. For example, the building integrator 605 may perform the method 2000. In some embodiments, the method 2000 and/or one or more steps thereof may be repeated, replaced, reproduced, alerted, modified, separated, omitted, and/or otherwise changed. While one or more steps of the method 2000 may have been described herein in a given order, this is for illustrative purposes only and is in no way limiting or indicative of how to implement the method 2000.

In some embodiments, at step 2005, the processing circuit 625 may provide a building management platform. For example, the processing circuit 625 may provide the building management platform responsive to a display device presenting, producing, or otherwise displays a user interface associated with the building management platform. The building management platform may refer to or include a web service or a cloud computing service. IN some embodiments, the processing circuit 625 may provide the building management platform to present one or more sets of information.

In some embodiments, at step 2010, the processing circuit 625 may receive a selection of an element of a user interface. For example, the user interface (presented in step 2005) may include one or more of elements, graphics, selectable portions, or segments. The processing circuit 625 may receive a selection of an element that pertains to performance or execution of one or more actions. The elements of the user interface can represent one or more functions. For example, the elements can represent functions that are different from one another (e.g., different functions). The functions may refer to or include one or more services or offerings provided by or implemented via the building management platform. For example, the functions may include at least one standard operating procedure function. In some embodiments, the standard operating procedure function may facilitate or otherwise provide services to create one or more standard operating procedures (e.g., new standard operating procedures).

In some embodiments, at step 2015, the processing circuit 625 may retrieve one or more data structures. For example, the processing circuit 625 may transmit one or more API calls to retrieve the data structures from a remote datastore. As another example, the processing circuit 625 may retrieve the data structures from one or more databases. In some embodiments, the one or more data structures may include information that represents one or more standard operating procedures. For example, the one or more data structures may include information that pertains to standard operating procedures that have been integrated with or implemented by a BMS. As another example, the one or more data structures may include information that pertains to standard operating procedures that are awaiting acceptance (e.g., not implemented or not integrated).

In some embodiments, at step 2020, the processing circuit 625 may update the user interface. For example, the user interface may (when first presented) include a first view. The processing circuit 625 may update the user interface to include a second view. In some embodiments, the first view of the user interface or the second view of the user interface may refer to or include at least one of the user interfaces or portions of the user interfaces described herein. For example, the first view of the user interface may refer to or include the user interface 700. As another example, the second view of the user interface may refer to or include the user interface 800.

In some embodiments, at step 2025, the processing circuit 625 may receive one or more indications. For example, the processing circuit 625 may receive an indication of a selection to create a new standard operating procedure. In some embodiments, the processing circuit 625 may receive the indication responsive to one or more selections of the elements included in the user interface. For example, the processing circuit 625 may receive the indication responsive to selection of the button 710 (e.g., a selectable element, an interactive icon, etc.).

In some embodiments, at step 2030, the processing circuit 625 may replace at least one portion of the user interface. For example, the processing circuit 625 may update the user interface to replace at least one portion with the area 820. In some embodiments, the processing circuit 625 may replace the at least one portion with an area that is configured to receive interactions to create one or more new standard operating procedures. For example, the area may provide space for which criteria or items may be connected to one another to create a new standard operating procedure.

In some embodiments, at step 2035, the processing circuit 625 may detect one or more interactions. For example, the processing circuit 625 may detect the placement or the positioning of the items 825 within the area 820. As another example, the processing circuit 625 may detect one or more connections between items. In some embodiments, the interactions may include or otherwise indicate one or more actions to include in the new standard operating procedure. For example, the interactions may indicate one or more automated control building functions (e.g., turn on lighting equipment, trigger an alarm, lock one or more doors, provide access to a space within the building, etc.).

In some embodiments, at step 2040, the processing circuit 625 may store one or more sets of information. For example, the processing circuit 625 may store information that represents the new standard operating procedure. As another example, the processing circuit 625 may store a digital rendition or a digital construct of the new standard operating procedure. In some embodiments, the processing circuit 625 may store the information in one or more databases. For example, the processing circuit 625 may store the information in the database that includes the data structures retrieved in step 2015.

In some embodiments, the new standard operating procedure may include or otherwise identify criteria. For example, the new standard operating procedure may include criteria to detect an intrusion event. The criteria may identify one or more pieces of information or data, that if true (e.g., detected, occurred, active, etc.) indicate an occurrence of the intrusion event. As another example, the new standard operating procedure may include criteria to establish one or more instances to publish alerts to one or more devices. The alerts may pertain to one or more pieces of equipment in which preventative maintenance or service has not occurred within a predetermined amount of time. For example, the alerts may pertain to one or more pieces of lighting equipment that have not been tested within the last 6 months.

In some embodiments, with respect to detection of the intrusion event, the criteria may indicate data (that if collected, objected, or detected by at least one camera) triggers a detection of the intrusion event. For example, the criteria may indicate that when a camera detects a person or object (within a closed section of a building or during evening hours) triggers a detection of an intrusion event. In some embodiments, the detection of the intrusion event may cause implementation of one or more actions. For example, the detection of the intrusion event may cause at least one action of a corresponding standard operating procedure to be implemented.

In some embodiments, the processing circuit 625 may implement the at least one action for the standard operating procedure that corresponds to the intrusion alert. Implementation of the at least one action may include the processing circuit 625 detecting an identification of the at least one camera. For example, the data collected by the at least one camera may include a model number or a serial number of the camera that collected the data associated with the detection of the intrusion event. In some embodiments, the processing circuit 625 may determine a location of the camera. For example, the processing circuit 625 may determine the location based on information associated with the building.

In some embodiments, the processing circuit 625 may query a digital representation (e.g., a digital twin, a building graph, a point mapping, etc.) to identify one or more pieces of lighting equipment that are located proximate to the camera. For example, the processing circuit 625 may query a building graph that includes stored space/equipment relationships (e.g., one or more pieces of equipment are located at one or more spaces within the building). Stated otherwise, the digital representation may refer to, include, or otherwise represent one or more stored relationships. In some embodiments, the digital representation and/or the digital twin of the building (as described herein) may refer to or include the digital twin described in U.S. patent application Ser. No. 17/134,664, filed Dec. 28, 2020, the entirety of which is incorporated by reference herein.

In some embodiments, with respect to establishment of the one or more instances to publish the alerts, the criteria may include an identification of an amount of time. For example, the criteria may include an indication that the one or more instances may be detected responsive to 15 days having elapsed since the last time a piece of lighting equipment was tested (e.g., a first event). In some embodiments, the processing circuit 625 may implement, responsive to detection of the one or more instances, at least one action included with a standard operating procedure that corresponds to the one or more instances. For example, the processing circuit 625 may retrieve one or more sets of data associated with performance of the first event. The one or more set of data may include a test log or a report generated as a result of testing the lighting equipment. In some embodiments, the processing circuit 625 may identify one or more devices. For example, the criteria may include a list of phone numbers or email address to provide the alert to. The processing circuit 625 may transmit one or more signals, to the one or more devices, to cause the one or more devices to display the alert. For example, the processing circuit 625 may transmit a push notification which causes the one or more devices to display a banner with the alert.

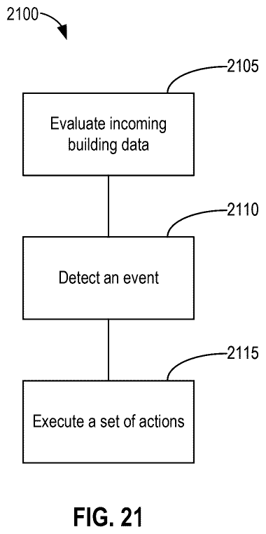

FIG. 21 depicts a flow diagram of a method 2100, according to some embodiments. The method 2100 may refer to or include one or more steps, actions, or processes associated with implementation of, execution of, or utilization of a workflow of a building (e.g., a stored workflow, an integrated workflow, etc.). For example, the method 2100 or one or more steps thereof may refer to or include the execution of a stored workflow. In some embodiments, the method 2100 or one or more steps thereof may be implemented by, performed by, or executed by one or more of the computing devices described herein. For example, the processing circuit 625 may implement at least one step of the method 2100. In some embodiments, the workflow may be stored, maintained, kept, or otherwise located in one or more databases.

In some embodiments, the workflow may be created, generated, or instantiated similar to one or more of the standard operating procedures described herein. For example, the workflow may be created via one or more interactions with the user interface 800. As another example, the workflow may be created via the user interface 900. In some embodiments, the workflow may establish, define, or otherwise include one or more criteria which establish when to implement, execute, or perform one or more actions for a building.

In some embodiments, at step 2105, the processing circuit 625 may evaluate incoming building data. For example, the processing circuit 625 may compile, aggregate, or otherwise receive building data as it is produced or otherwise provided by building equipment. In some embodiments, the processing circuit 625 may evaluate the incoming building data relative to one or more conditions or criteria. For example, one or more stored workflows and/or active workflows may include conditions (e.g., event occurrences, data metrics, etc.) that may be satisfied or otherwise triggered based on the building data.

In some embodiments, the conditions may be satisfied based on the incoming building data. For example, the incoming building data may include camera data (represented as a video feed, image frames, data strings, etc.) that is generated, collected, or obtained by a camera. The camera data or corresponding information may include given data strings which indicate statuses or occurrences within the building. In some embodiments, the camera data may include data strings which indicate an event. For example, the camera data may include a data string that indicates an intrusion event. As another example, the camera data may include data strings which indicate a presence of an object. As another example, the camera data may include data strings to indicate an activation of a fire alarm. As another example, the camera data may include data strings to indicate a utilization of a door or other access point within the building.

In some embodiments, at step 2110, the processing circuit 625 may detect an event. For example, the processing circuit 625 may detect an intrusion event based on the camera data satisfying the condition. Stated otherwise, the stored workflow may define, establish, or indicate criteria for the camera data, which when present or detected triggers detection of the intrusion event. In some embodiments, the intrusion event may refer to or include an unauthorized entrance or access of the building, a presence of an individual during a zone or space of a building for which the individual is not authorized to be in, a door-forced open event, or among other possible events. The intrusion event may be captured (e.g., recorded, digitally recorded, or otherwise obtained) by at least one camera that is located proximate to the event.

In some embodiments, at step 2115, the processing circuit 625 may execute a set of actions. For example, the processing circuit 625 may execute one or more actions defined by the stored workflow having the condition satisfied by the camera data. In some embodiments, the processing circuit 625 may execute the set of actions to address or otherwise remediate the event detected in step 2110. The set of actions may refer to or include at least one of the actions described herein.

In some embodiments, the processing circuit 625 may identify a building space observed by the camera based on the camera data. For example, the processing circuit 625 may identify a building space (e.g., a zone, floor, room, wing, etc.) of the building that is observed by the camera (e.g., within view, included in the line of sight of the camera, visible from the camera, etc.). In some embodiments, the processing circuit 625 may identify the building space based on information collected by the camera (e.g., the camera data). For example, the camera data may include a location stamp or an indication of the building space for which the camera is observing or otherwise collecting information about. As another example, the processing circuit 625 may access or otherwise utilize a digital map or floor plan of the building, which includes indications of which zones or spaces of the building are captured by respective cameras.

In some embodiments, the processing circuit 625 may query a digital representation of the building. For example, the processing circuit 625 may query a digital twin to identify lighting equipment. The processing circuit 625 may identify the lighting equipment based on one or more connections or relationships between points or data objects that represent the camera and the lighting equipment. Stated otherwise, the processing circuit 625 may detect connections or links between respective points of the digital twin. For example, the camera may be a first data node or point within the digital twin. The first data node may include an edge or connection to a second data node or second point that represents the lighting equipment. In some embodiments, the processing circuit 625 may identify the lighting equipment responsive to detection of the connection between the camera and the lighting equipment within the digital twin.

In some embodiments, the processing circuit 625 may operate or otherwise control the lighting equipment. For example, the processing circuit 625 may transmit one or more control signals which cause the lighting equipment to illuminate (e.g., emit light, produced light, etc.) the building space observed by the camera. Stated otherwise, the processing circuit 625 may cause the lighting equipment to produce light within or proximate to the area of the building for which the event was detected. As another example, if the lighting equipment was producing light during the occurrence or detection of the occurrence of the event, the processing circuit 625 may operate the lighting equipment such that the lighting equipment continues to produce light or otherwise illuminate the area.

In some embodiments, the processing circuit 625 may cause one or more cameras to generate a recording. For example, the processing circuit 625 may transmit one or more signals or inputs (to a camera associated with detection of the event) to cause the camera to generate a recording (e.g., a collection of image frames, a video, a digital image, etc.) of the space that is observed by the camera. Stated otherwise, the processing circuit 625 may cause the camera to generate or otherwise capture a recording of the space for which the event was detected. In some embodiments, the processing circuit 625 may implement or otherwise initiate one or more of the automated video gathering processes described in U.S. patent application Ser. No. 18/895,903, filed Sep. 25, 2024, the entirety of which is incorporated by reference herein.

In some embodiments, the processing circuit 625 may store the recording. For example, the processing circuit 625 may add or otherwise ingest a node (into a digital twin) that represents the recording (along with an indication of a location in memory for which the recording is stored). As another example, the processing circuit 625 may store the recording by transmit one or more push requests to a remote or cloud data repository. In some embodiments, the processing circuit 625 may store the recording in accordance with the workflow. For example, the workflow may specify or otherwise indicate a given memory device or database to store the recording.

In some embodiments, the processing circuit 625 may transmit one or more signals to cause the recording to be presenting. For example, the processing circuit 625 may transmit one or more push notifications to a display device (e.g., a monitor, a kiosk, a TV, a tablet, a laptop, a computer, a smart phone, etc.) to cause the display device to present the recording. Stated otherwise, the processing circuit 625 may transmit one or more signals that cause the display device to generate a user interface to present the recording.

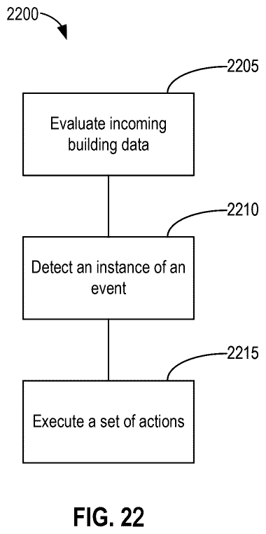

FIG. 22 depicts a flow diagram of a method 2200, according to some embodiments. The method 2200 may refer to or include one or more steps, actions, or processes performed while executing a workflow or while a workflow is active. For example, the method 2200 may include one or more steps associated with implementation of a stored workflow that pertains to equipment maintenance alerts. In some embodiments, the method 2200 or one or more steps thereof may be implemented by, performed by, or executed by one or more of the computing devices described herein. For example, the processing circuit 625 may implement at least one step of the method 2200. In some embodiments, the workflow may be stored, maintained, kept, or otherwise located in one or more databases.

In some embodiments, at step 2205, the processing circuit 625 may evaluate incoming building data. For example, the processing circuit 625 may compile, aggregate, or otherwise receive building data as it is produced or otherwise provided by building equipment. As another example, the incoming building data may include daily logs, weekly logs, or monthly logs that pertain to testing routine, preventative maintenance, service works, or otherwise upkeep performed on building equipment. In some embodiments, the processing circuit 625 may evaluate the incoming building data relative to one or more conditions or criteria. For example, one or more stored workflows and/or active workflows may include conditions (e.g., event occurrences, data metrics, etc.) that may be satisfied or otherwise triggered based on the building data.

In some embodiments, the conditions and/or conditional logic may be satisfied based on the incoming building data. For example, the incoming building data may include reports logs (for lighting equipment) which indicate the most recent point in time for which the lighting equipment underwent a testing routine. As another example, the incoming building data may include a list of dates for which the lighting equipment was evaluated or otherwise examined.

In some embodiments, at step 2210, the processing circuit 625 may detect an instance of an event. For example, the processing circuit 625 may detect that an amount of time since or subsequent to a testing routine for lighting equipment has exceeded a threshold (e.g., an event). As another example, the processing circuit 625 may detect that a number of operation hours (e.g., hours producing light) for a bulb or light source of the lighting equipment has exceeded a threshold. In some embodiments, the processing circuit 625 may detect the instance of the event based on the incoming building data. For example, the processing circuit 625 may extract or otherwise identify (via optical character recognition) dates for respective testing routines. Based on the most recently identified date, the processing circuit 625 may determine that the condition of the stored workflow is satisfied (e.g., conditional logic is true or otherwise met).

In some embodiments, at step 2215, the processing circuit 625 may execute a set of actions. For example, the processing circuit 625 may execute one or more actions included in or otherwise defined by the stored workflow that corresponds to the lighting equipment. In some embodiments, the processing circuit 625 may execute the actions to address, remediate, or otherwise account for the detection of the event. For example, the processing circuit 625 may execute one or more actions to instantiate a system reboot or a system recalibration of the lighting equipment.

In some embodiments, the processing circuit 625 may retrieve one or more sets of data associated with the event. For example, the processing circuit 625 may retrieve one or more testing results or outcomes associated with implementation of a testing routine on the lighting equipment. As another example, the processing circuit 625 may retrieve one or more manuals associated with the lighting equipment. In some embodiments, the processing circuit 625 may retrieve one or more sets of data for inclusion in a push notification or alert.

In some embodiments, the processing circuit 625 may identify one or more devices. For example, the stored workflow may indicate one or more devices (e.g., smart phones, cell phones, kiosk, monitors, computers, etc.) to transmit or otherwise provide an alert of the instance of the event. In some embodiments, the processing circuit 625 may identify the devices based on an evaluation of the stored workflow.

In some embodiments, the processing circuit 625 may transmit one or more signals. For example, the processing circuit 625 may transmit signals to cause one or more devices to display a digital banner or message associated with detection of the instance of the event. As another example, the processing circuit 625 may transmit one or more signals to cause the one or more devices to display or otherwise receive a message (e.g., an SMS message, an RCS message, an email, etc.).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

What is claimed is:

1. A building system for monitoring and controlling a building, the building system comprising one or more memory devices storing instructions thereon that, when executed by one or more processors, cause the one or more processors to:
evaluate incoming building data generated by building equipment of the building relative to a condition defined by a stored workflow, the incoming building data comprising camera data generated by a camera of the building;
detect an event in response to the camera data satisfying the condition of the stored workflow; and
execute, responsive to detection of the event, a set of actions defined by the stored workflow, the set of actions comprising:
identifying a building space observed by the camera based on the camera data;
querying a digital representation of the building to identify lighting equipment operable to illuminate the building space observed by the camera; and
operating the lighting equipment to illuminate the building space observed by the camera.

2. The building system of claim 1, wherein the digital representation is a digital twin including a plurality of points having one or more connections to indicate relationships between respective points of the plurality of points, wherein the camera is represented within the digital twin as a first point of the plurality of points, wherein the lighting equipment is represented within the digital twin as a second point of the plurality of points, wherein the first point is connected to the second point via a first connection of the one or more connections, and wherein the instructions cause the one or more processors to:
detect, responsive to querying the digital twin, the first connection between the first point and the second point;
determine, based on one or more relationships indicated by the first connection, that the second point pertains to the lighting equipment; and
identify the lighting equipment based at least on the second point pertaining to the lighting equipment.

3. The building system of claim 1, wherein the event is an intrusion event, and wherein the instructions further cause the one or more processors to:
monitor the camera data for one or more criteria that define the intrusion event; and
detect the intrusion event in response to the one or more criteria being satisfied.

4. The building system of claim 1, wherein the digital representation is a digital twin, and wherein the instructions further cause the one or more processors to:
identify the building space observed by the camera using a stored relationship of the digital twin that is between the camera and a location of the camera.

5. The building system of claim 1, wherein identifying the building space observed by the camera includes:
determining a location of the camera and an orientation of the camera, wherein the location of the camera is within the building space observed by the camera or a second building space proximate to the building space observed by the camera.

6. The building system of claim 1, wherein querying the digital representation includes:
identifying a stored relationship in the digital representation between the building space observed by the camera and the lighting equipment.

7. The building system of claim 1, wherein the instructions further cause the one or more processors to:
create the stored workflow, and wherein creation of the stored workflow includes the one or more processors to:
replace, responsive to receipt of a first indication, at least one portion of a user interface with an area configured to receive interactions to create the stored workflow;
detect one or more interactions with the area, the one or more interactions including a second indication of the set of actions for inclusion in the stored workflow; and
store one or more sets of information associated with the one or more interactions to create the stored workflow having the set of actions.

8. The building system of claim 1, wherein the stored workflow is associated with a stored standard operating procedure, and wherein the instructions further cause the one or more processors to:
determine to initiate an instance of the stored standard operating procedure using data obtained from one or more functions of a plurality of different functions of a building management platform; and
execute, responsive to initiation of the instance of the stored standard operating procedure, at least one action associated with the stored standard operating procedure to:
retrieve one or more sets of information from one or more platforms of a building management system; and
transmit one or more signals to cause the one or more platforms to control one or more aspects of the building based on the one or more sets of information.

9. The building system of claim 1, wherein the building includes one or more aspects that pertain to at least one of energy consumption of the building, statuses of the building equipment of the building, previously detected faults for the building equipment, or maintenance records for the building equipment.

10. The building system of claim 1, wherein the instructions cause the one or more processors to:
transmit one or more Application Programming Interface (API) calls to retrieve one or more sets of information that indicate one or more aspects of the building; and
ingest, responsive to retrieval of the one or more sets of information, at least a portion of the one or more sets of information into a building management platform to provide a context of the building.

11. The building system of claim 1, wherein the instructions cause the one or more processors to:
detect, via one or more interactions with a user interface, a selection of at least one second stored workflow awaiting acceptance prior to integration with one or more building systems of the building;
update, responsive to detection of the selection of the at least one second stored workflow, the user interface to display one or more actions to perform the at least one second stored workflow; and
integrate, responsive to acceptance of the at least one second stored workflow via the user interface, the at least one second stored workflow with the one or more building systems.

12. The building system of claim 1, wherein the set of actions further include:
causing, responsive to detection of the event, the camera to generate a recording of the building space observed by the camera;
storing, responsive to generation of the recording, the recording in the digital representation of the building; and
transmitting one or more signals to a display device to cause the display device to present the recording.

13. A method, comprising:
evaluating, by one or more processing circuits, incoming building data generated by building equipment of a building relative to a condition defined by a stored workflow, the incoming building data comprising camera data generated by a camera of the building;
detecting, by the one or more processing circuits, an event in response to the camera data satisfying the condition of the stored workflow; and
executing, by the one or more processing circuits, responsive to detecting the event, a set of actions defined by the stored workflow, the set of actions comprising:
identifying a building space observed by the camera based on the camera data;
querying a digital representation of the building to identify lighting equipment operable to illuminate the building space observed by the camera; and
operating the lighting equipment to illuminate the building space observed by the camera.

14. The method of claim 13, wherein the digital representation is a digital twin including a plurality of points having one or more connections to indicate relationships between respective points of the plurality of points, wherein the camera is represented within the digital twin as a first point of the plurality of points, wherein the lighting equipment is represented within the digital twin as a second point of the plurality of points, wherein the first point is connected to the second point via a first connection of the one or more connections, and further comprising:
detecting, by the one or more processing circuits, responsive to querying the digital twin, the first connection between the first point and the second point;
determining, by the one or more processing circuits, based on one or more relationships indicated by the first connection, that the second point pertains to the lighting equipment; and
identifying, by the one or more processing circuits, the lighting equipment based at least on the second point pertaining to the lighting equipment.

15. The method of claim 13, wherein the event is an intrusion event, and further comprising:
monitoring, by the one or more processing circuits, the camera data for one or more criteria that define the intrusion event; and
detecting, by the one or more processing circuits, the intrusion event in response to the one or more criteria being satisfied.

16. The method of claim 13, wherein the digital representation is a digital twin, and further comprising:
identifying, by the one or more processing circuits, the building space observed by the camera using a stored relationship of the digital twin that is between the camera and a location of the camera.

17. The method of claim 13, wherein identifying the building space observed by the camera includes:
determining, by the one or more processing circuits, a location of the camera and an orientation of the camera, wherein the location of the camera is within the building space observed by the camera or a second building space proximate to the building space observed by the camera.

18. A building system for monitoring and controlling a building, the building system comprising one or more memory devices storing instructions thereon that, when executed by one or more processors, cause the one or more processors to:
evaluate incoming building data associated with building equipment of the building relative to a condition defined by a stored workflow, the incoming building data comprising data associated with lighting equipment of the building;
detect an instance of an event based on the data associated with the lighting equipment satisfying the condition of the stored workflow; and
execute, responsive to detection of the instance of the event, a set of actions defined by the stored workflow, the set of actions comprising:
retrieving one or more sets of data associated the event;
identifying one or more devices; and
transmitting, to the one or more devices, one or more signals to cause the one or more devices to display an alert and the one or more sets of data.

19. The building system of claim 18, wherein the instructions further cause the one or more processors to:
monitor the data associated with the lighting equipment for one or more criteria that define the condition; and
detect the instance of the event in response to the one or more criteria being satisfied.

20. The building system of claim 18, wherein the instructions further cause the one or more processors to:
identify the data associated with the lighting equipment using a stored relationship of a digital twin that is between the lighting equipment and the data associated with the lighting equipment.
